(19) United States
(12) Patent Application Publication
(10) Pub. No.: US 2023/0245319 A1
(43) Pub. Date: Aug. 3, 2023

(54) IMAGE PROCESSING APPARATUS, IMAGE PROCESSING METHOD, LEARNING DEVICE, LEARNING METHOD, AND PROGRAM

(71) Applicant: SONY GROUP CORPORATION, TOKYO (JP)

(72) Inventors: KOJI NISHIDA, TOKYO (JP); TAKURO KAWAI, TOKYO (JP)

(21) Appl. No.: 17/998,610

(22) PCT Filed: May 7, 2021
(86) PCT No.: PCT/JP2021/017534

§ 371 Date: Nov. 11, 2022

(30) Foreign Application Priority Data
May 21, 2020 (JP) 2020-088840

(51) Int. Cl. G06T 7/12; G06T 7/73

(52) U.S. Cl. CPC G06T 7/12; G06T 7/74; G06T 2207/20132; G06T 2207/20081

(57) ABSTRACT

The present technology relates to an image processing apparatus, an image processing method, a learning device, a learning method, and a program, for enabling to easily realizing segmentation along a boundary of an object. An image processing apparatus according to one aspect of the present technology inputs, to an inference model, as an input image for determination, an image of a region including at least a part of each superpixel constituting a combination of any plurality of superpixels, in a processing target image including an object; infers whether or not a plurality of superpixels constituting the combination is superpixels of a same object; and aggregates superpixels constituting the processing target image for each object on the basis of an inference result obtained using the inference model. The present technology can be applied to various devices that handle images, such as TVs, cameras, and smartphones.

### TECHNICAL FIELD

The present technology particularly relates to an image processing apparatus, an image processing method, a learning device, a learning method, and a program capable of easily realizing segmentation along a boundary of an object.

### BACKGROUND ART

In a case of performing image processing, it is sometimes desired to adjust a type and intensity of image processing for each object. As preprocessing in such a case of performing image processing, processing called segmentation may be used. Segmentation is a process of sectioning an image for each region including meaningful pixels, such as a region where a same object appears.

In a conventional segmentation using a feature amount of a pixel, such as a position and a pixel value of the pixel, it is difficult to recognize an object having a plurality of features as one object and to section the object into one region. An object or the like including a plurality of parts may have a plurality of features.

Patent Document 1 discloses a technique of determining a local score for each combination of each superpixel constituting an image in which a cell nucleus appears and any superpixel located within a search radius from each superpixel, and identifying a global set of superpixels.

### CITATION LIST

### Patent Document

Patent Document 1: Japanese Patent Application Laid-Open No. 2019-502994

### SUMMARY OF THE INVENTION

### Problems to be Solved by the Invention

The technique described in Patent Document 1 is difficult to use for processing on an object included in a general image because there is a restriction on a target object.

As a method of classifying each pixel constituting an image on the basis of meaning thereof, semantic segmentation using a deep neural network (DNN) is conceivable. However, a boundary of an object becomes ambiguous since only likelihood with low reliability can be obtained as a reference value of classification.

The present technology has been made in view of such a situation, and makes it possible to easily realize segmentation along a boundary of an object.

### Solutions to Problems

An image processing apparatus according to one aspect of the present technology includes: an inference unit configured to input, to an inference model, as an input image for determination, an image of a region including at least a part of each superpixel constituting a combination of any plurality of superpixels, in a processing target image including an object, and to infer whether or not a plurality of superpixels constituting the combination is superpixels of a same object; and an aggregation unit configured to aggregate superpixels constituting the processing target image for each object on the basis of an inference result obtained using the inference model.

A learning device according to another aspect of the present technology includes: a student image creation unit configured to create, as a student image, an image of a region including at least a part of each superpixel constituting a combination of any plurality of superpixels, in a processing target image including an object; a teacher data calculation unit configured to calculate teacher data according to whether or not a plurality of superpixels constituting the combination is superpixels of a same object, on the basis of a label image corresponding to the processing target image; and a learning unit configured to learn a coefficient of an inference model by using a learning patch including the student image and the teacher data.

In one aspect of the present technology, to an inference model, as an input image for determination, an image of a region including at least a part of each superpixel constituting a combination of any plurality of superpixels is inputted in a processing target image including an object, inference is made as to whether or not a plurality of superpixels constituting the combination is superpixels of a same object, and superpixels constituting the processing target image is aggregated for each object on the basis of an inference result obtained using the inference model.

In another aspect of the present technology, as a student image, an image of a region including at least a part of each superpixel constituting a combination of any plurality of superpixels is created in a processing target image including an object, teacher data according to whether or not a plurality of superpixels constituting the combination is superpixels of a same object is calculated on the basis of a label image corresponding to the processing target image, and a coefficient of an inference model is learned by using a learning patch including the student image and the teacher data.

### BRIEF DESCRIPTION OF DRAWINGS

FIG. 1 is a diagram illustrating a configuration example of an image processing system according to an embodiment of the present technology.

FIG. 2 is a view illustrating an example of an image to be used for learning.

FIG. 3 is a view illustrating an example of segmentation.

FIG. 4 is a view illustrating an example of aggregation of superpixels.

FIG. 5 is a block diagram illustrating a configuration example of a learning patch creation unit.

FIG. 6 is a flowchart illustrating a learning patch creation process.

FIG. 7 is a view illustrating an example of an input image.

FIG. 8 is a view illustrating an example of a clipped image.

FIG. 9 is a view illustrating an example of a clipped image.

FIG. 10 is a view illustrating an example of calculation of correct answer data.

FIG. 11 is a block diagram illustrating a configuration example of a learning unit.

FIG. 12 is a flowchart illustrating a learning process.

FIG. 13 is a block diagram illustrating a configuration example of an inference unit.

FIG. 14 is a flowchart illustrating an inference process.

FIG. 15 is a block diagram illustrating a configuration example of an image processing apparatus.

FIG. 16 is a flowchart illustrating processing of the image processing apparatus having the configuration of FIG. 15.

FIG. 17 is a view illustrating an example of learning data.

FIG. 18 is a view illustrating an example of learning data.

FIG. 19 is a view illustrating an example of a learning patch.

FIG. 20 is a block diagram illustrating a configuration example of the image processing apparatus.

FIG. 21 is a flowchart illustrating processing of the image processing apparatus having the configuration of FIG. 20.

FIG. 22 is a view illustrating an example of screen display of an annotation tool.

FIG. 23 is a block diagram illustrating a configuration example of the image processing apparatus.

FIG. 24 is a flowchart illustrating processing of the image processing apparatus having the configuration of FIG. 23.

FIG. 25 is a flowchart following FIG. 24.

FIG. 26 is a block diagram illustrating another configuration example of the image processing apparatus.

FIG. 27 is a flowchart illustrating processing of the image processing apparatus having the configuration of FIG. 26.

FIG. 28 is a flowchart following FIG. 27.

FIG. 29 is a block diagram illustrating a configuration example of a computer.

### MODE FOR CARRYING OUT THE INVENTION

Hereinafter, an embodiment for implementing the present technology will be described. The description will be given in the following order.

1. Basic configuration of image processing system

2. Application example 1: example of application to image processing apparatus that performs image processing for each object

3. Application example 2: example of application to image processing apparatus for recognizing boundary of object

4. Application example 3: example of application to annotation tool

5. Other

<<Basic Configuration of Image Processing System>>

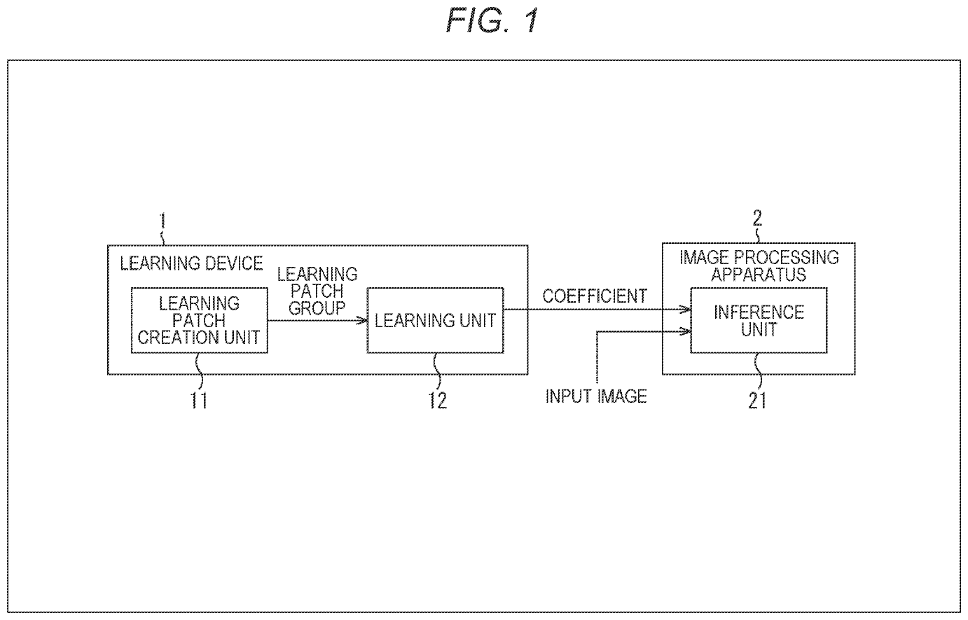

FIG. 1 is a diagram illustrating configuration example of an image processing system according to an embodiment of the present technology.

The image processing system in FIG. 1 includes a learning device 1 and an image processing apparatus 2. The learning device 1 and the image processing apparatus 2 may be realized by devices in the same housing, or may be realized individually by devices in different housings.

In the image processing system of FIG. 1, a function is realized for aggregating superpixels calculated using a general segmentation technology for each object, by using an inference model such as a deep neural network (DNN) obtained by deep learning.

Learning of the DNN to be used to aggregate superpixels is performed by the learning device 1. Whereas, a process of aggregating superpixels on the basis of an inference result obtained by using the DNN is performed by the image processing apparatus 2.

Note that, the superpixel is each region calculated by segmentation. As a segmentation technique, there are techniques such as SLIC and SEEDS. The SLIC and the SEEDS are disclosed in, for example, the following documents.

SLIC

Achanta, Radhakrishna, et al. “SLIC superpixels compared to state-of-the-art superpixel methods.” IEEE transactions on pattern analysis and machine intelligence 34.11 (2012):2274-2282.

SEEDS

Van den Bergh, Michael, et al. “Seeds: Superpixels extracted via energy-driven sampling.” European conference on computer vision. Springer, Berlin, Heidelberg, 2012.

The learning device 1 includes a learning patch creation unit 11 and a learning unit 12.

The learning patch creation unit 11 creates a learning patch serving as learning data of a coefficient of each layer constituting the DNN. The learning patch creation unit 11 outputs a learning patch group including a plurality of learning patches, to the learning unit 12.

The learning unit 12 learns the coefficients of the DNN by using the learning patch group created by the learning patch creation unit 11. The learning unit 12 outputs the coefficients obtained by learning to the image processing apparatus 2.

The image processing apparatus 2 is provided with an inference unit 21. As will be described later, the image processing apparatus 2 is also provided with a configuration that performs various types of image processing on the basis of an inference result obtained by the inference unit 21. To the inference unit 21, an input image to be a processing target is inputted together with the coefficient outputted from the learning unit 12. For example, an image of each frame constituting a moving image is inputted to the inference unit 21 as an input image.

The inference unit 21 performs segmentation on the input image, and calculates a superpixel. Furthermore, the inference unit 21 performs inference by using the DNN configured by the coefficients supplied from the learning unit 12, and calculates a value serving as a reference for aggregating each superpixel.

For example, the inference unit 21 calculates similarity between any given two superpixels. On the basis of the similarity calculated by the inference unit 21, a process of aggregating superpixels and the like are performed in a processing unit in a subsequent stage.

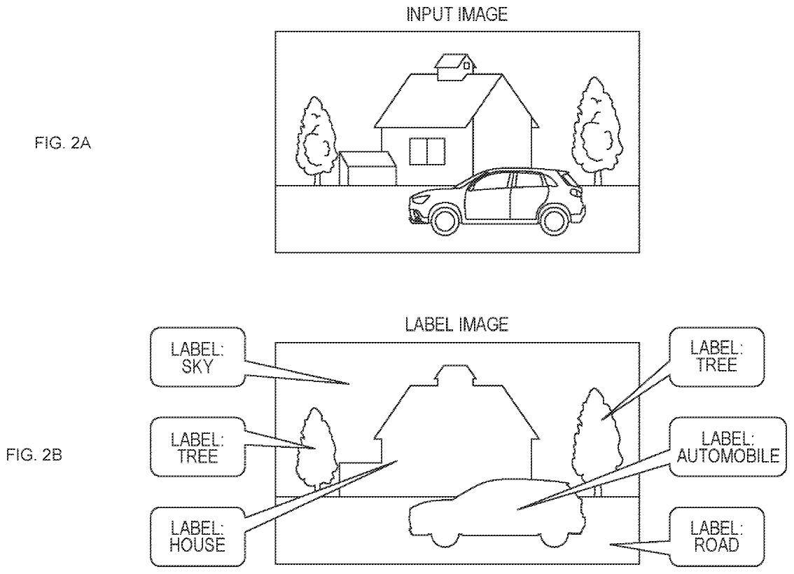

FIG. 2 is a view illustrating an example of an image to be used for learning.

For learning of a similarity determination coefficient that is a coefficient of the DNN that outputs similarity between two superpixels, an input image and a label image corresponding to the input image are used. The label image is an image in which a label is set for each region (pixels constituting each region) constituting the input image, by performing annotation. A learning set including a plurality of pairs of the input image and the label image as illustrated in A of FIG. 2 and B of FIG. 2 is inputted to the learning patch creation unit 11.

In the example of B of FIG. 2, a label of “sky” is set in a region where sky appears as a subject, and a label of “automobile” is set in a region where an automobile appears. A label is similarly set in each of regions in which other objects appear.

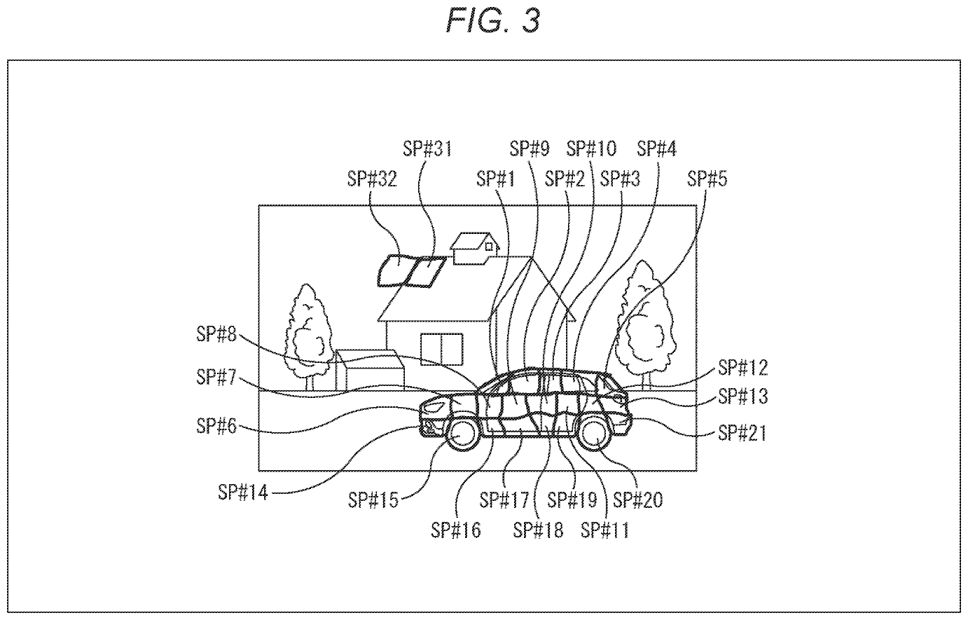

FIG. 3 is a view illustrating an example of segmentation.

In a case where segmentation is performed on the input image in A of FIG. 2, the region of the automobile is sectioned into Superpixel #1 (SP #1) to Superpixel #21 (SP #21), for example, as illustrated in FIG. 3. Since feature amounts such as color and brightness are different, a body portion is sectioned as Superpixel #5 to Superpixel #21, and a window portion is sectioned as Superpixel #1 to Superpixel #4.

Furthermore, Superpixel #31 is formed in a partial region of a roof of a house, and Superpixel #32 is formed in a partial region of sky adjacent to Superpixel #31. In the example of FIG. 3, only Superpixel #31 and Superpixel #32 are illustrated in addition to the region of the automobile, but in practice, the entire input image is sectioned into superpixels.

In an image processing unit (not illustrated) of the image processing apparatus 2, it is sometimes desired to adjust, for each object, a type and intensity of image processing for an input image as a target. For example, since Superpixel #1 to Superpixel #21 are superpixels constituting the same automobile, there is a case where it is preferable to aggregate Superpixel #1 to Superpixel #21 as superpixels constituting a same object.

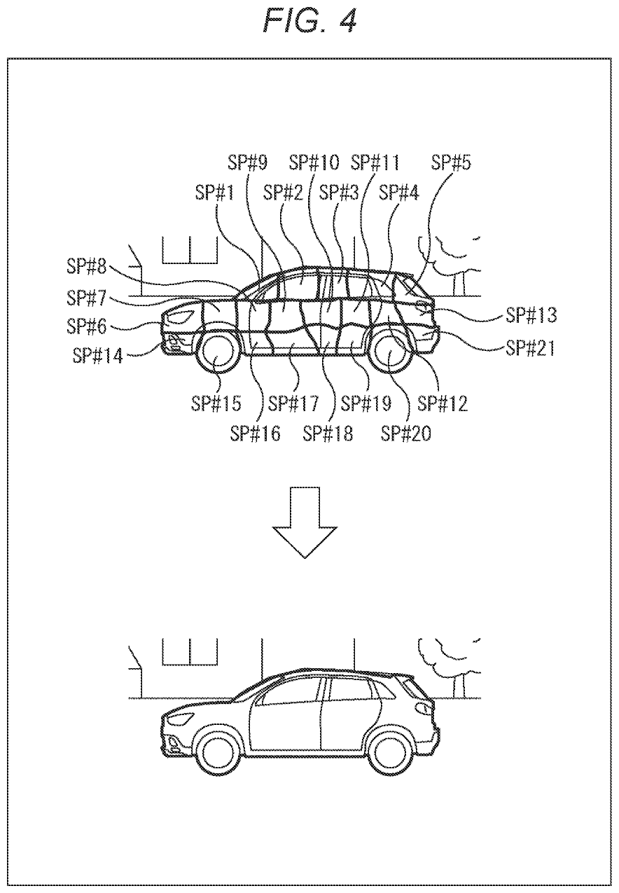

In the learning device 1, for example, in a case where segmentation as illustrated in FIG. 3 is performed, learning of the DNN for calculating similarity serving as a reference for aggregating Superpixel #1 to Superpixel #21 as superpixels constituting a same object is performed as illustrated in FIG. 4. In the example of FIG. 4, Superpixel #1 to Superpixel #21 are aggregated into one superpixel.

That is, in the learning device 1, learning of the DNN is performed for inferring that Superpixel #1 to Superpixel #21 constituting a region where the same label of “automobile” is set are similar superpixels (value 1). Furthermore, learning of the DNN is performed for inferring that Superpixel #31 constituting a region where a label of “house” is set and Superpixel #32 constituting a region where the label of “sky” is set are dissimilar superpixels (value 0).

As a result, superpixels constituting a same object can be aggregated in the image processing unit of the image processing apparatus 2, and the same image processing can be performed on the entire region of the object.

<Creation of Learning Patch>

Configuration of Learning Patch Creation Unit 11

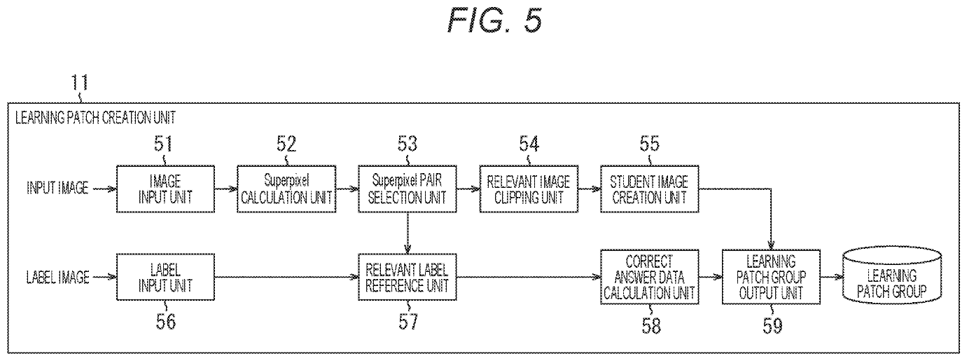

FIG. 5 is a block diagram illustrating a configuration example of the learning patch creation unit 11 of the learning device 1.

The learning patch creation unit 11 includes an image input unit 51, a superpixel calculation unit 52, a superpixel pair selection unit 53, a relevant image clipping unit 54, a student image creation unit 55, a label input unit 56, a relevant label reference unit 57, a correct answer data calculation unit 58, and a learning patch group output unit 59. To the learning patch creation unit 11, a learning set including an input image and a label image is supplied.

The image input unit 51 acquires the input image included in the learning set, and outputs to the superpixel calculation unit 52. The input image outputted from the image input unit 51 is also supplied to each unit such as the relevant image clipping unit 54.

The superpixel calculation unit 52 performs segmentation on the input image as a target, and outputs information about each calculated superpixel to the superpixel pair selection unit 53.

The superpixel pair selection unit 53 selects a combination of two superpixels from a superpixel group calculated by the superpixel calculation unit 52, and outputs information about the superpixel pair to the relevant image clipping unit 54 and the relevant label reference unit 57.

The relevant image clipping unit 54 clips each region including pixels of two superpixels constituting the superpixel pair, from the input image. The relevant image clipping unit 54 outputs a clipped image including the region clipped from the input image, to the student image creation unit 55.

The student image creation unit 55 creates a student image on the basis of the clipped image supplied from the relevant image clipping unit 54. The student image is created on the basis of pixel data of two superpixels constituting the superpixel pair. The student image creation unit 55 outputs the student image to the learning patch group output unit 59.

The label input unit 56 acquires a label image corresponding to the input image from the learning set, and outputs to the relevant label reference unit 57.

The relevant label reference unit 57 refers to each label of two superpixels selected by the superpixel pair selection unit 53, on the basis of the label image. The relevant label reference unit 57 outputs information about each label to the correct answer data calculation unit 58.

The correct answer data calculation unit 58 calculates correct answer data on the basis of each label of the two superpixels. The correct answer data calculation unit 58 outputs the calculated correct answer data to the learning patch group output unit 59.

The learning patch group output unit 59 sets the correct answer data supplied from the correct answer data calculation unit 58 as teacher data, and creates a set of the teacher data and the student image supplied from the student image creation unit 55, as one learning patch. The learning patch group output unit 59 creates a sufficient amount of learning patches, and outputs as a learning patch group.

Operation of Learning Patch Creation Unit 11

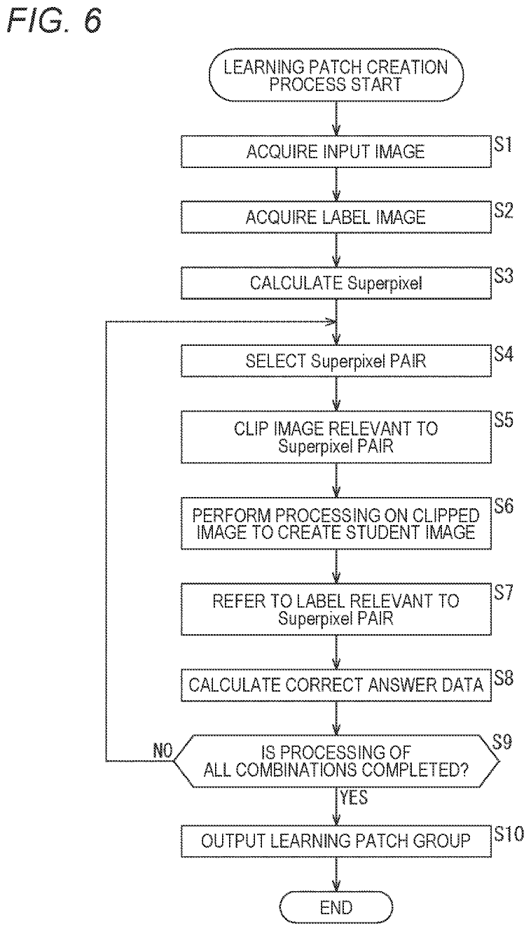

A learning patch creation process will be described with reference to a flowchart of FIG. 6.

In step S1, the image input unit 51 acquires an input image from a learning set.

In step S2, the label input unit 56 acquires a label image corresponding to the input image from the learning set.

The subsequent processes are sequentially performed on, as a target, all pairs of the input image and the label image included in the learning set.

In step S3, the superpixel calculation unit 52 calculates a superpixel. That is, the superpixel calculation unit 52 performs segmentation on the input image as a target by using a known technique, and collects all the pixels of the input image into superpixels, a number of which is smaller than a number of pixels.

In step S4, the superpixel pair selection unit 53 selects any one superpixel as a target superpixel, from the superpixel group calculated by the superpixel calculation unit 52. Furthermore, the superpixel pair selection unit 53 selects any one superpixel different from the target superpixel, as a comparison superpixel.

For example, one superpixel adjacent to the target superpixel is selected as the comparison superpixel. Furthermore, one superpixel within a range of a predetermined distance from the target superpixel is selected as the comparison superpixel. The comparison superpixel may be randomly selected.

The superpixel pair selection unit 53 sets a pair of the target superpixel and the comparison superpixel as a superpixel pair. Each of all combinations of superpixels including superpixels at distant positions may be selected as the superpixel pair, or only a predetermined number of superpixel pairs may be selected. The manner of selecting superpixels to be the superpixel pair and the number of superpixel pairs can be freely changed.

In step S5, the relevant image clipping unit 54 clips an image relevant to the superpixel pair.

In step S6, the student image creation unit 55 performs processing such as a resolution reduction process on the clipped image clipped by the relevant image clipping unit 54, to create a student image.

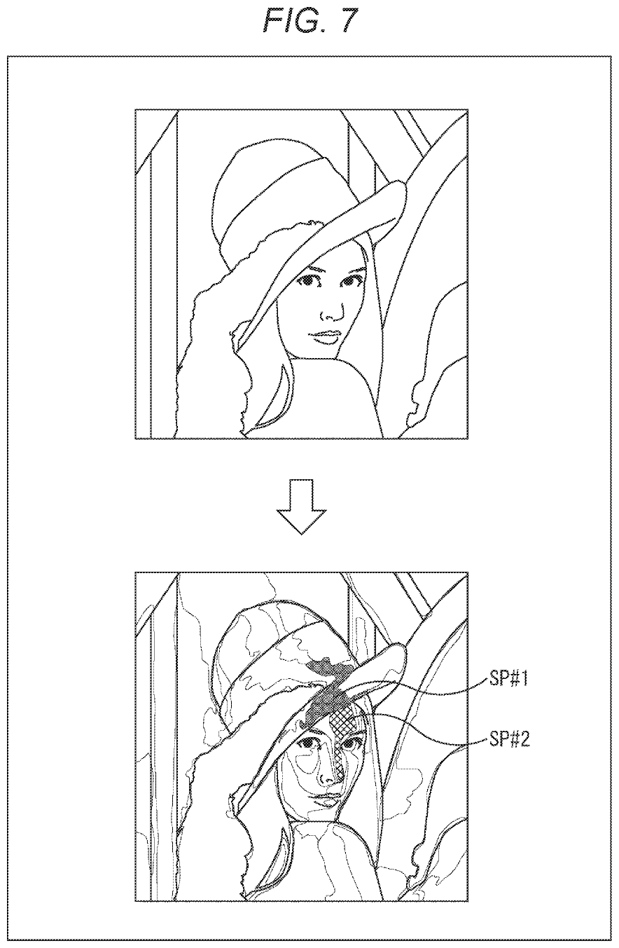

FIG. 7 is a view illustrating an example of the input image.

An upper part of FIG. 7 represents the input image, and a lower part represents a segmentation result. In the lower part of FIG. 7, each region sectioned by a contour line is a superpixel calculated by segmentation.

A description is given to an example of clipping a region in a case where Superpixel #1 and Superpixel #2 indicated by adding color and the like in the lower part of FIG. 7 are selected as a superpixel pair. In this example, one superpixel adjacent to the target superpixel is selected as the comparison superpixel. A region including a pixel of Superpixel #1 and a region including a pixel of Superpixel #2 are clipped from the input image by the relevant image clipping unit 54.

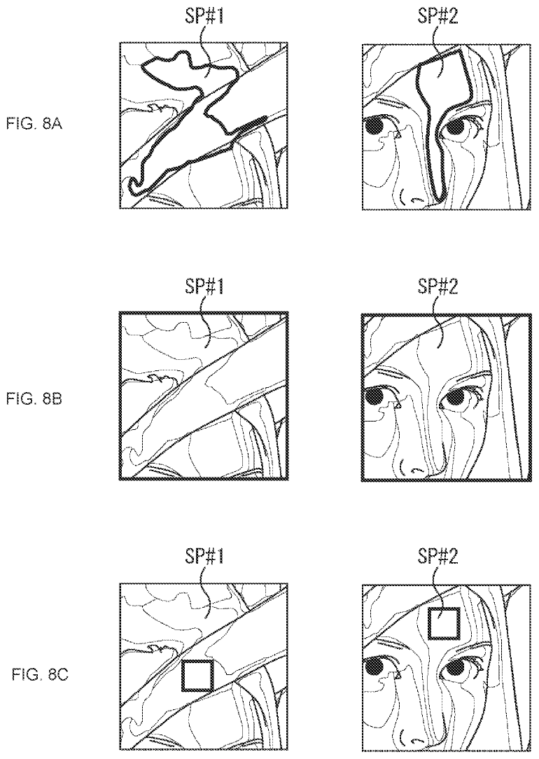

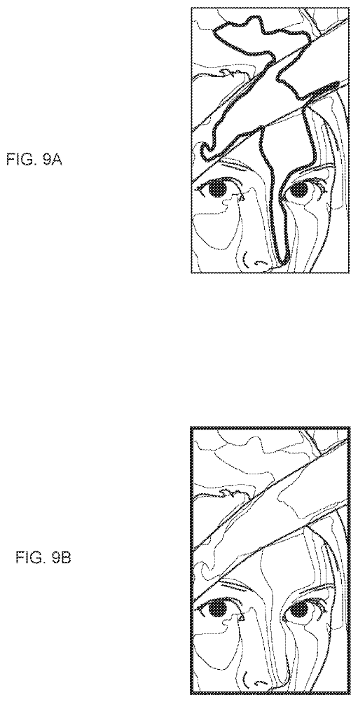

FIGS. 8 and 9 are views illustrating examples of clipped images.

### Example 1 of Clipped Image

A of FIG. 8 illustrates an example of a case where a pixel of Superpixel #1 and a pixel of Superpixel #2 are individually clipped as clipped images. There are created a clipped image including a pixel of Superpixel #1 indicated by being surrounded with a thick line on a left side and a clipped image including a pixel of Superpixel #2 indicated by being surrounded with a thick line on a right side.

### Example 2 of Clipped Image

B of FIG. 8 illustrates an example of a case where a pixel in a rectangular region including Superpixel #1 and a pixel in a rectangular region including Superpixel #2 are individually clipped as clipped images. There are created a clipped image including a pixel in the rectangular region indicated by being surrounded with a thick line on a left side, and a clipped image including a pixel in the rectangular region indicated by being surrounded with a thick line on a right side.

### Example 3 of Clipped Image

C of FIG. 8 illustrates an example of a case where a pixel in a partial rectangular region in Superpixel #1 and a pixel in a partial rectangular region in Superpixel #2 are individually clipped as clipped images. There are created a clipped image including a pixel in a small rectangular region in Superpixel #1 indicated by being surrounded with a thick line on a left side, and a clipped image including a pixel in a small rectangular region in Superpixel #2 indicated by being surrounded with a thick line on a right side.

### Example 4 of Clipped Image

A of FIG. 9 illustrates an example of a case where pixels in the entire region in which Superpixel #1 and Superpixel #2 are added are clipped as a clipped image. There is created a clipped image including a pixel in a region indicated by being surrounded with a thick line in which Superpixel #1 and Superpixel #2 are added.

### Example 5 of Clipped Image

B of FIG. 9 illustrates an example of a case where a pixel in a rectangular region including a region obtained by adding Superpixel #1 and Superpixel #2 are clipped as a clipped image. The clipped image is created including a pixel of a vertically long and large rectangular region that is indicated by being surrounded with a thick line and includes a region obtained by adding Superpixel #1 and Superpixel #2.

In this way, the clipping of the clipped image is performed such that a region including at least a part of each superpixel constituting the superpixel pair is clipped from the input image. As described above, the student image is created on the basis of the clipped image clipped from the input image. For example, in a case where the clipped image illustrated in A of FIG. 8 is created, two images obtained by processing two clipped images are created as the student images.

Note that, in a case where the clipped image is created such that one region is clipped as illustrated in FIG. 9, learning of a DNN having a network structure using one student image as an input is performed.

Returning to the description of FIG. 6, in step S7, the relevant label reference unit 57 refers to the respective labels of the target superpixel and the comparison superpixel constituting the superpixel pair.

In step S8, the correct answer data calculation unit 58 calculates correct answer data on the basis of the individual labels of the target superpixel and the comparison superpixel.

The correct answer data is similarity between labels of two superpixels constituting a superpixel pair. For example, a similarity value of 1 indicates that the labels of two superpixels are the same. Furthermore, a similarity value of 0 indicates that the labels of two superpixels are different.

In this case, the correct answer data calculation unit 58 calculates, as the correct answer data, the value 1 in a case where the labels of the two superpixels constituting the superpixel pair are the same, and the value 0 in a case where the labels are different.

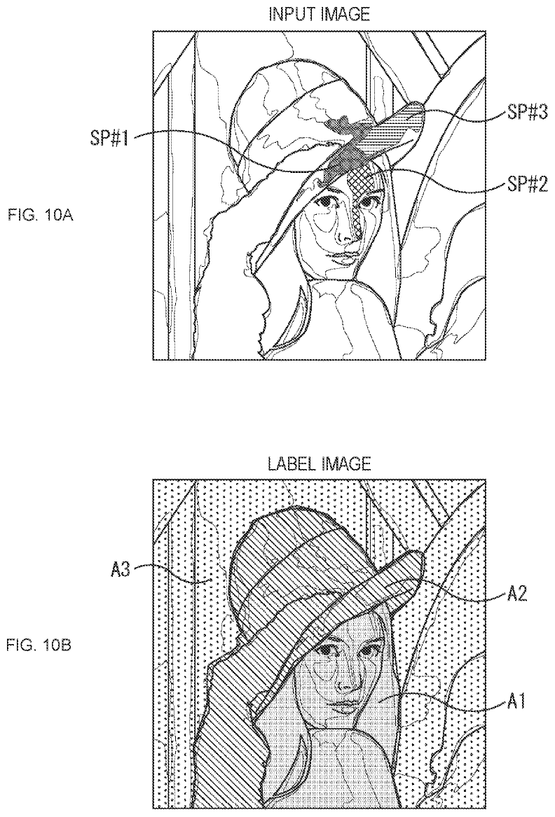

FIG. 10 is a view illustrating an example of calculation of correct answer data.

In a case where Superpixel #1 and Superpixel #2 illustrated in A of FIG. 10 are selected as a superpixel pair, the value 0 is calculated as the correct answer data. As illustrated in B of FIG. 10, Superpixel #1 and Superpixel #2 are superpixels for which different labels are set individually.

In B of FIG. 10, a label of “person” is set in a region A1 including a face of a person indicated by adding color, and a label of “hat” is set in a region A2 including a hat indicated by hatching with diagonal lines. Furthermore, a label “background” is set in a background region A3 indicated by hatching with dots.

Similarly, in a case where Superpixel #2 and Superpixel #3 are selected as a superpixel pair, the value 0 is calculated as the correct answer data.

Whereas, in a case where Superpixel #1 and Superpixel #3 are selected as a superpixel pair, the value 1 is calculated as the correct answer data. As illustrated in B of FIG. 10, Superpixel #1 and Superpixel #3 are superpixels for which the same label of “hat” is set.

Here, the value of the correct answer data is assumed to be 1 or 0, but other values may be used.

Furthermore, a fractional value may be used as the correct answer data.

Depending on the superpixel, there is a case where a plurality of labels is set. In this case, the correct answer data calculation unit 58 calculates a fractional value between 0 to 1 as the correct answer data in accordance with a ratio of pixels for which the same label is set or in accordance with a ratio of pixels for which different labels are set, in the entire superpixel region.

A fractional value between 0 to 1 may be calculated as the correct answer data, by using information other than the label. For example, it is determined whether or not two superpixels are similar on the basis of a local feature amount such as brightness and variance of pixel values, and the value of the correct answer data is adjusted in combination with information about the label.

Even in a case where labels of two superpixels constituting a superpixel pair are different, the value of the correct answer data may be adjusted such that a fractional value between 0 to 1 is used for similar labels.

For example, in a case where similar labels such as “tree” and “grass” are set to two superpixels, a fractional value such as 0.5 is calculated in accordance with a degree of similarity.

Furthermore, in the input image illustrated in A of FIG. 10, in a case where a face region and a hair region are individually set as regions of different labels, the labels are different from each other. However, the labels are for regions of the same person and are similar, and thus a value of 0.5 is calculated as the correct answer data.

Returning to the description of FIG. 6, in step S9, the learning patch group output unit 59 determines whether or not the processing of all the superpixel pairs is completed. In a case where it is determined in step S9 that the processing of all the superpixel pairs is not completed, the process returns to step S4, and the above process is repeated by changing the superpixel pair.

In a case where it is determined in step S9 that the processing of all the superpixel pairs is completed, in step S10, the learning patch group output unit 59 outputs the learning patch group and ends the process.

The learning patch group output unit 59 sets a pair of the student image and the correct answer data as one learning patch, and collects the learning patches for all the superpixel pairs. Further, the learning patch group output unit 59 collects the learning patch collected from one pair of the input image and the label image for all pairs of the input image and the label image included in the learning set, and outputs the learning patches as a learning patch group.

All the learning patches may be outputted as the learning patch group, or only learning patches satisfying a predetermined condition may be outputted as the learning patch group.

In a case where only the learning patches satisfying the predetermined condition are to be outputted, for example, there is performed a process of removing a learning patch including a student image having only flat pixel information such as sky from the learning patch group. Furthermore, a process of reducing a ratio of a learning patch including a student image generated on the basis of pixel data of a superpixel at a distant position is performed.

Note that, correct answer data in a case where a clipped image is created such that one region is clipped as illustrated in FIG. 9 is calculated as follows.

For example, in a case where the clipped image is created as illustrated in A of FIG. 9, the value 1 is calculated as the correct answer data in a case where all the pixels of one student image are pixels for which a same label is set, and the value 0 is calculated as the correct answer data in a case where pixels for which two or more labels are set are included in one student image. It is also possible to calculate a fractional value as the correct answer data in accordance with a ratio of pixels for which different labels are set. In this case, for example, the value 1 is calculated in a case where the ratio of pixels for which different labels are set is 10% or less, a value 0.5 is calculated in a case where the ratio is 20%, and the value 0 is calculated in a case where the ratio is 30% or more.

Furthermore, in a case where the clipped image is created as illustrated in B of FIG. 9, the correct answer data is calculated in accordance with a ratio of pixels for which different labels are set among pixels of the student image. It is also possible to increase a weight of a pixel in a central portion of a screen and reduce a weight of a pixel in a peripheral portion.

<Learning of Similarity Determination Coefficient>

Configuration of Learning Unit 12

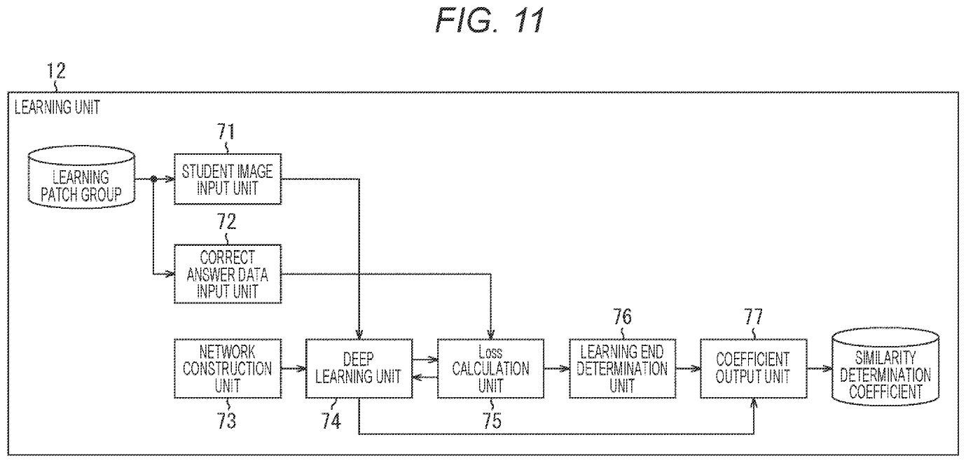

FIG. 11 is a block diagram illustrating a configuration example of the learning unit 12 of the learning device 1.

The learning unit 12 includes a student image input unit 71, a correct answer data input unit 72, a network construction unit 73, a deep learning unit 74, a loss calculation unit 75, a learning end determination unit 76, and a coefficient output unit 77. A learning patch group created by the learning patch creation unit 11 is supplied to the student image input unit 71 and the correct answer data input unit 72.

The student image input unit 71 reads learning patches one by one and acquires a student image. The student image input unit 71 outputs the student image to the deep learning unit 74.

The correct answer data input unit 72 reads learning patches one by one, and acquires correct answer data corresponding to the student image acquired by the student image input unit 71. The correct answer data input unit 72 outputs the correct answer data to the loss calculation unit 75.

The network construction unit 73 constructs a learning network. A network having any structure used in existing deep learning is used as the learning network.

Learning of a single-layer network may be performed instead of a multi-layer network. Furthermore, a transformation model for transforming a feature amount of an input image into similarity may be used for calculating similarity.

The deep learning unit 74 inputs the student image to an input layer of the network, and sequentially performs convolution (convolution operation) of each layer. A value corresponding to similarity is outputted from an output layer of the network. The deep learning unit 74 outputs the value of the output layer to the loss calculation unit 75. Coefficient information of each layer of the network is supplied to the coefficient output unit 77.

The loss calculation unit 75 compares an output of the network with correct answer data to calculate a loss, and updates the coefficient of each layer of the network so as to reduce the loss. In addition to the loss of a learning result, a validation set may be inputted to the network, and a validation loss may be calculated. Loss information calculated by the loss calculation unit 75 is supplied to the learning end determination unit 76.

The learning end determination unit 76 determines whether or not to end the learning on the basis of the loss calculated by the loss calculation unit 75, and outputs a determination result to the coefficient output unit 77.

In a case where the learning end determination unit 76 determines to end the learning, the coefficient output unit 77 outputs the coefficient of each layer of the network as a similarity determination coefficient.

Operation of Learning Unit 12

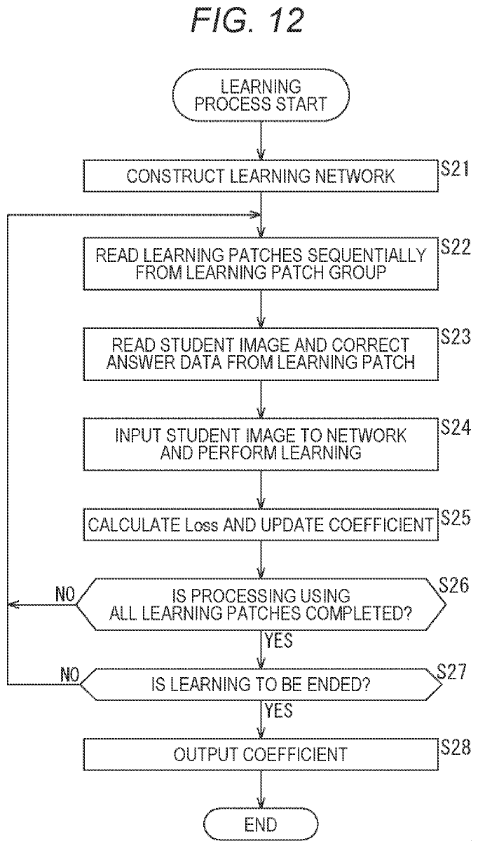

A learning process will be described with reference to a flowchart of FIG. 12.

In step S21, the network construction unit 73 constructs a learning network.

In step S22, the student image input unit 71 and the correct answer data input unit 72 sequentially read learning patches one by one from a learning patch group.

In step S23, the student image input unit 71 acquires a student image from the learning patch. Furthermore, the correct answer data input unit 72 acquires correct answer data from the learning patch.

In step S24, the deep learning unit 74 inputs the student image to the network, and sequentially performs convolution of each layer.

In step S25, the loss calculation unit 75 calculates a loss on the basis of an output of the network and the correct answer data, and updates a coefficient of each layer of the network.

In step S26, the learning end determination unit 76 determines whether or not the processing using all the learning patches included in the learning patch group is completed. In a case where it is determined in step S26 that the processing using all the learning patches is not completed, the process returns to step S22, and the above process is repeated using the next learning patch.

In a case where it is determined in step S26 that the processing using all the learning patches is completed, in step S27, the learning end determination unit 76 determines whether or not to end the learning. Whether or not to end the learning is determined on the basis of the loss calculated by the loss calculation unit 75.

In a case where it is determined in step S27 not to end the learning because the loss is not sufficiently small, the process returns to step S22, the learning patch group is read again, and the learning of the next epoch is repeated. Learning of inputting the learning patch to the network and updating the coefficient is repeated about 100 times.

Whereas, in a case where it is determined in step S27 to end the learning because the loss becomes sufficiently small, the coefficient output unit 77 outputs the coefficient of each layer of the network as a similarity determination coefficient in step S28, and ends the process.

<Similarity Inference>

Configuration of Inference Unit 21

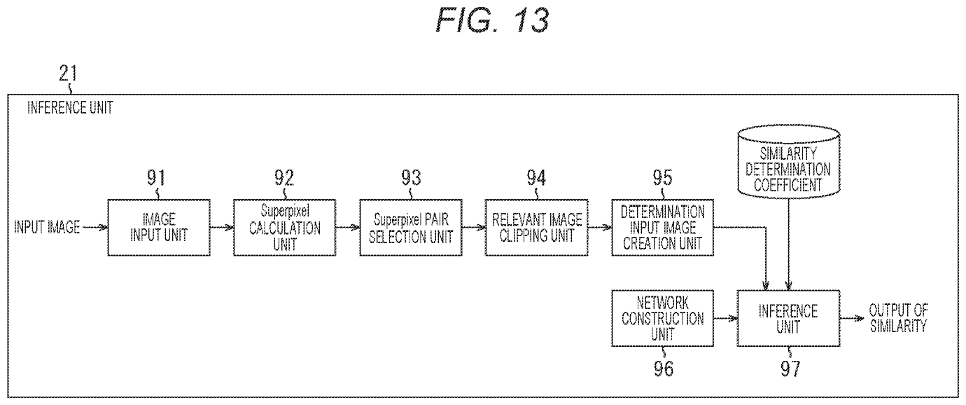

FIG. 13 is a block diagram illustrating a configuration example of the inference unit 21 of the image processing apparatus 2.

The inference unit 21 includes an image input unit 91, a superpixel calculation unit 92, a superpixel pair selection unit 93, a relevant image clipping unit 94, a determination input image creation unit 95, a network construction unit 96, and an inference unit 97. To the image input unit 91, an input image to be a processing target is supplied. Furthermore, to the inference unit 97, a similarity determination coefficient outputted from the learning unit 12 is supplied.

The image input unit 91 acquires the input image, and outputs to the superpixel calculation unit 92. The input image outputted from the image input unit 91 is also supplied to each unit such as the relevant image clipping unit 94.

The superpixel calculation unit 92 performs segmentation on the input image as a target, and outputs information about each calculated superpixel to the superpixel pair selection unit 93.

The superpixel pair selection unit 93 selects a combination of two superpixels whose similarity is desired to be determined from a superpixel group calculated by the superpixel calculation unit 92, and outputs information about the superpixel pair to the relevant image clipping unit 94.

The relevant image clipping unit 94 clips each region including pixels of two superpixels constituting the superpixel pair, from the input image. The relevant image clipping unit 94 outputs a clipped image including the region clipped from the input image, to the determination input image creation unit 95.

The determination input image creation unit 95 creates an image for determination on the basis of the clipped image supplied from the relevant image clipping unit 94. The input image for determination is created on the basis of pixel data of the two superpixels constituting the superpixel pair. The determination input image creation unit 95 outputs the input image for determination to the inference unit 97.

The network construction unit 96 constructs an inference network. A network having the same structure as the learning network is used as the inference network. As a coefficient of each layer constituting the inference network, the similarity determination coefficient supplied from the learning unit 12 is used.

The inference unit 97 inputs the input image for determination to an input layer of the inference network, and sequentially performs convolution of each layer. A value corresponding to similarity is outputted from an output layer of the inference network. The inference unit 97 outputs the value of the output layer as the similarity.

Operation of Inference Unit 21

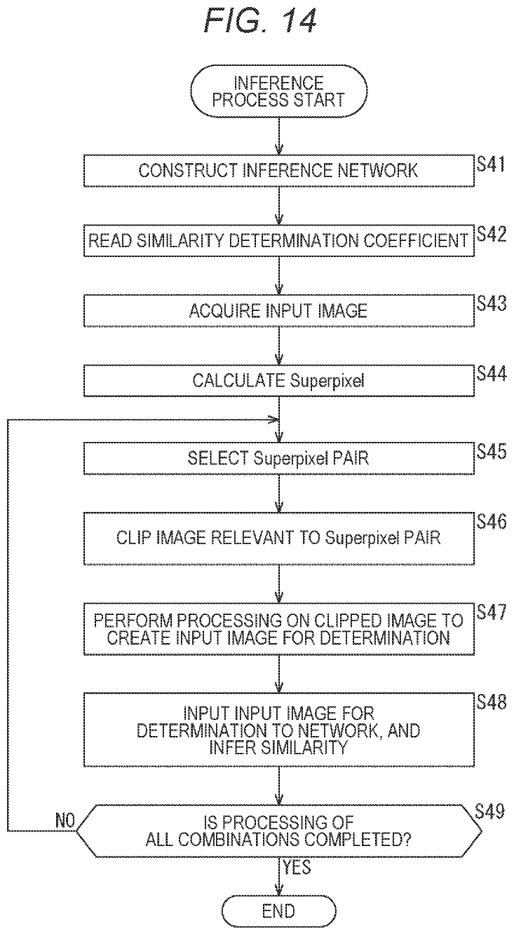

An inference process will be described with reference to a flowchart of FIG. 14.

In step S41, the network construction unit 96 constructs an inference network.

In step S42, the inference unit 97 reads a similarity determination coefficient, and sets in each layer of the inference network.

In step S43, the image input unit 91 acquires an input image.

In step S44, the superpixel calculation unit 92 calculates a superpixel. That is, the superpixel calculation unit 92 performs segmentation using a known technique on the input image as a target, and collects all the pixels of the input image into superpixels, a number of which is smaller than the number of pixels.

In step S45, the superpixel pair selection unit 93 selects two superpixels whose similarity is desired to be determined, from a superpixel group calculated by the superpixel calculation unit 92.

In step S46, the relevant image clipping unit 94 clips an image of a region relevant to the superpixel pair from the input image. The clipped image is clipped in a similar manner to when the student image is created at the time of learning.

In step S47, the determination input image creation unit 95 performs processing such as a resolution reduction process on the clipped image clipped by the relevant image clipping unit 94, to create an input image for determination.

In step S48, the inference unit 97 inputs the input image for determination to the inference network, and performs similarity inference.

In step S49, the inference unit 97 determines whether or not the processing of all the superpixel pairs is completed. In a case where it is determined in step S49 that the processing of all the superpixel pairs is not completed, the process returns to step S45, and the above process is repeated by changing the superpixel pair.

In a case where it is determined in step S49 that the processing of all the superpixel pairs is completed, the process ends. The similarity of all the superpixel pairs is supplied from the inference unit 21 to an image processing unit in a subsequent stage.

Through the above series of processing, it is possible to specify whether or not two superpixels are superpixels constituting a same object, simply by inputting, to the DNN, an image including the two superpixels whose similarity is desired to be determined. Since superpixels can be aggregated for each object on the basis of a determination result of similarity, segmentation along a boundary of an object can be easily realized.

### <<Application Example 1: Example of Application to Image Processing Apparatus that Performs Image Processing for Each Object>>

An inference result obtained by the inference unit 21 can be used for image processing for each object. Such image processing is performed in various image processing apparatuses that handle images, such as TVs, cameras, and smartphones.

Configuration of Image Processing Apparatus 2

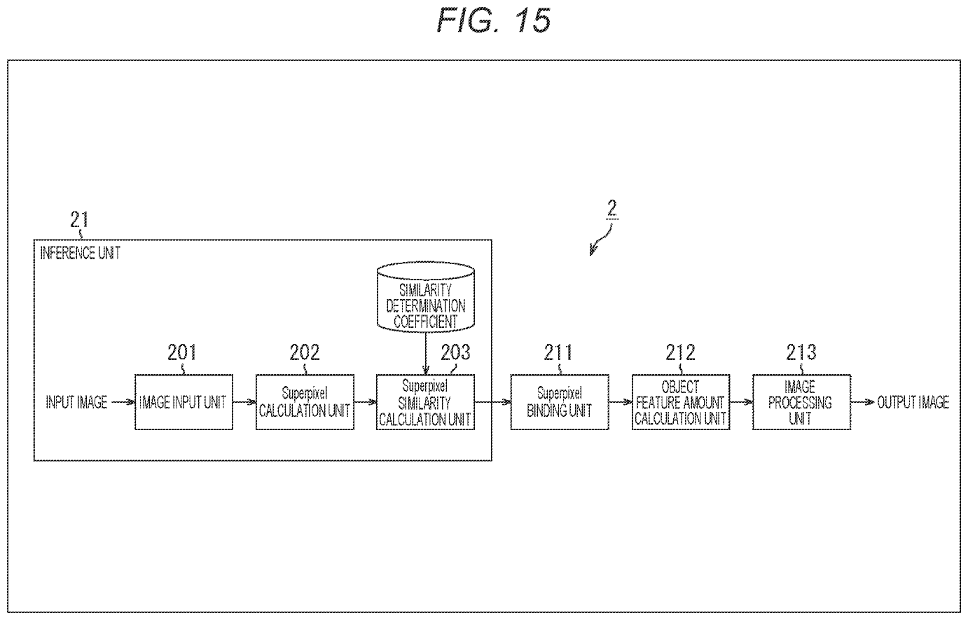

FIG. 15 is a block diagram illustrating a configuration example of the image processing apparatus 2.

In the image processing apparatus 2 illustrated in FIG. 15, after the entire input image is sectioned into superpixels, the superpixels are aggregated for each object, a feature amount for each object is calculated, and a process of adjusting a type and intensity of image processing is performed on the basis of a result.

As illustrated in FIG. 15, a superpixel binding unit 211, an object feature amount calculation unit 212, and an image processing unit 213 are provided in a subsequent stage of the inference unit 21.

The inference unit 21 includes an image input unit 201, a superpixel calculation unit 202, and a superpixel similarity calculation unit 203. The image input unit 201 corresponds to the image input unit 91 in FIG. 13, and the superpixel calculation unit 202 corresponds to the superpixel calculation unit 92 in FIG. 13. The superpixel similarity calculation unit 203 corresponds to a configuration in which the superpixel pair selection unit 93 to the inference unit 97 in FIG. 13 are integrated. Redundant description will be omitted as appropriate.

The image input unit 201 acquires and outputs an input image. The input image outputted from the image input unit 201 is supplied to the superpixel calculation unit 202, and is also supplied to each unit in FIG. 15.

The superpixel calculation unit 202 performs segmentation on the input image as a target, and outputs information about each calculated superpixel to the superpixel similarity calculation unit 203. The superpixel may be calculated by any algorithm such as SLIC or SEEDS. Simple block sectioning can also be performed.

The superpixel similarity calculation unit 203 calculates (infers) similarity for all superpixels calculated by the superpixel calculation unit 202 and adjacent superpixels, and outputs the similarity to the superpixel binding unit 211.

The superpixel binding unit 211 aggregates superpixels of a same object into one superpixel, on the basis of the similarity calculated by the superpixel similarity calculation unit 203. Information about superpixels aggregated by the superpixel binding unit 211 is supplied to the object feature amount calculation unit 212.

The object feature amount calculation unit 212 analyzes the input image, and calculates a feature amount for each object on the basis of superpixels aggregated by the superpixel binding unit 211. Information about the feature amount for each object calculated by the object feature amount calculation unit 212 is supplied to the image processing unit 213.

The image processing unit 213 adjusts a type and intensity of image processing for each object, and performs image processing on the input image. Various types of image processing such as noise removal and super-resolution are performed on the input image.

Operation of Image Processing Apparatus 2

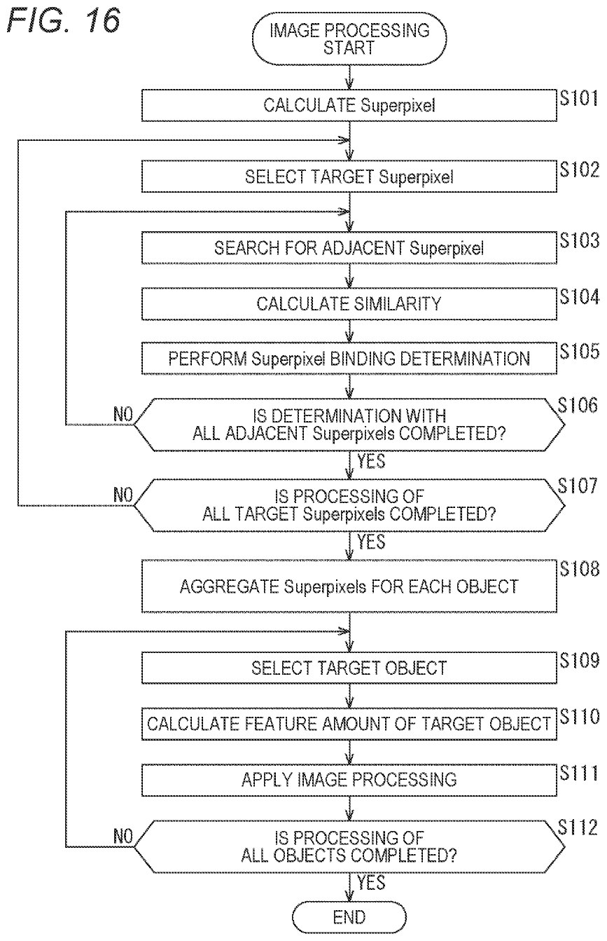

With reference to a flowchart of FIG. 16, processing of the image processing apparatus 2 having the configuration of FIG. 15 will be described. The processing of FIG. 16 is started when the input image acquired by the image input unit 201 is supplied to each unit.

In step S101, the superpixel calculation unit 202 performs segmentation on the input image as a target, and collects all the pixels of the input image into superpixels, a number of which is smaller than a number of pixels.

In step S102, the superpixel similarity calculation unit 203 selects, as a target superpixel, one superpixel to be a determination target from the superpixel group calculated by the superpixel calculation unit 202. For example, all the superpixels constituting the input image are individually set as the target superpixels, and the subsequent processes are performed.

In step S103, the superpixel similarity calculation unit 203 searches for a superpixel adjacent to the target superpixel, and selects one superpixel adjacent to the target superpixel as an adjacent superpixel.

In step S104, the superpixel similarity calculation unit 203 calculates similarity between the target superpixel and the adjacent superpixel.

That is, similarly to the time of learning, by creating a clipped image by clipping an image relevant to the target superpixel and the adjacent superpixel from the input image and processing the clipped image, the superpixel similarity calculation unit 203 creates an input image for determination. The superpixel similarity calculation unit 203 inputs the input image for determination to the inference network, and calculates similarity. Information about the similarity calculated by the superpixel similarity calculation unit 203 is supplied to the superpixel binding unit 211.

In step S105, the superpixel binding unit 211 performs superpixel binding determination on the basis of the similarity calculated by the superpixel similarity calculation unit 203.

For example, the superpixel binding unit 211 determines whether or not two superpixels are superpixels of a same object, on the basis of the similarity between the target superpixel and the adjacent superpixel. In the case of the above-described example, when the value of the similarity is 1, the target superpixel and the adjacent superpixel are determined to be superpixels of a same object. Whereas, when the similarity value is 0, the target superpixel and the adjacent superpixel are determined to be superpixels of different objects.

In a case where the similarity is represented by a fractional value, the fractional value is compared with a threshold value, and it is determined whether or not the target superpixel and the adjacent superpixel are superpixels of a same object.

The binding determination by the superpixel binding unit 211 may be performed by combining feature amounts such as a distance and a spatial distance of pixel values of pixels constituting two superpixels, in addition to the similarity.

In step S106, the superpixel similarity calculation unit 203 determines whether or not the binding determination with all the adjacent superpixels is completed. In a case where it is determined in step S106 that the binding determination with all the adjacent superpixels is not completed, the process returns to step S103, and the above process is repeated by changing the adjacent superpixel.

In order to reduce a processing time, the binding determination may be performed only between with a superpixel adjacent to the target superpixel.

Furthermore, the binding determination may be performed between with all superpixels within a range of a predetermined distance, with reference to a position of the target superpixel. By performing the binding determination between with only superpixels within the range of the predetermined distance, a calculation amount can be reduced.

It is also possible to cause the binding determination to be performed between with all superpixels including superpixels at distant positions. By calculating similarity with all other superpixels for each superpixel, superpixels at distant positions can be aggregated.

In a case where it is determined in step S106 that the binding determination with all the adjacent superpixels is completed, in step S107, the superpixel similarity calculation unit 203 determines whether or not the processing of all the target superpixels is completed. In a case where it is determined in step S107 that the processing of all the target superpixels is not completed, the process returns to step S102, and the above process is repeated by changing the target superpixel.

In a case where it is determined in step S107 that the processing of all the target superpixels is completed, the superpixel binding unit 211 aggregates superpixels for each object in step S108. Here, aggregation of superpixels is performed such that the target superpixel and the adjacent superpixel determined to be superpixels of a same object are bound. Of course, three or more superpixels may be aggregated.

The calculation amount may be reduced by calculating similarity between all superpixels to create a graph, and aggregating superpixels by a graph cut method.

In step S109, the object feature amount calculation unit 212 selects a target object.

In step S110, the object feature amount calculation unit 212 analyzes the input image, and calculates a feature amount of the target object. For example, the object feature amount calculation unit 212 calculates local feature amounts of all the pixels constituting the input image, and calculates an average of the local feature amounts of the pixels constituting the target object as the feature amount of the target object. The pixels constituting the target object are specified by the superpixel of the aggregated target object.

In step S111, the image processing unit 213 selects a type of image processing or adjusts a parameter that defines intensity of image processing, in accordance with the feature amount of the target object. As a result, the image processing unit 213 can adjust the parameter with high accuracy for each object, as compared with a case of adjusting the parameter on the basis of a local feature amount or a feature amount for each superpixel.

The image processing unit 213 performs image processing on the input image on the basis of the adjusted parameter. A feature amount map may be created in which a feature amount for each object is developed in all the pixels constituting the object, and image processing may be performed for each pixel in accordance with a value of the feature amount map. Image processing according to the feature amount of the object is performed on pixels constituting each object constituting the input image.

In step S112, the image processing unit 213 determines whether or not the processing of all the objects is completed. In a case where it is determined in step S112 that the processing of all the objects is not completed, the process returns to step S109, and the above process is repeated by changing the target object.

In a case where it is determined in step S112 that the processing of all the objects is completed, the process ends.

In a case where the processing target image is a moving image, the series of processing above is repeated with each frame constituting the moving image as an input image. In this case, it is possible to improve efficiency of processing by using information about a previous frame, for processing such as calculation of a superpixel or binding determination for a certain frame as a target.

With the above process, it is possible to perform adjustment with high accuracy according to a feature of an object, as compared with a case of adjusting a parameter of the image processing on the basis of a local feature amount.

In a case where the parameters of the image processing are adjusted in units of blocks, there is a possibility that the parameters are not separated along a boundary of the object. However, such a situation can be prevented.

In a case where superpixels are aggregated on the basis of a result of semantic segmentation, and image processing is performed in units of aggregation, a boundary of an object becomes ambiguous, and an artifact may occur protruding from the boundary of the object. However, such a situation can be prevented.

<<Application Example 2: Example of Application to Image Processing Apparatus for Recognizing Boundary of Object>>

An inference result obtained by the inference unit 21 can be used to recognize a boundary of an object. The recognition of the boundary of the object by using the inference result obtained by the inference unit 21 is performed in various image processing apparatuses such as an in-vehicle device, a robot, and an AR device. The inference unit 21 is to be used as an object boundary determiner.

For example, in an in-vehicle device, control of automated driving, display of a guide for a driver, and the like are performed on the basis of a recognition result of a boundary of an object. Furthermore, in a robot, an operation such as holding an object with a robot arm is performed on the basis of a recognition result of a boundary of an object.

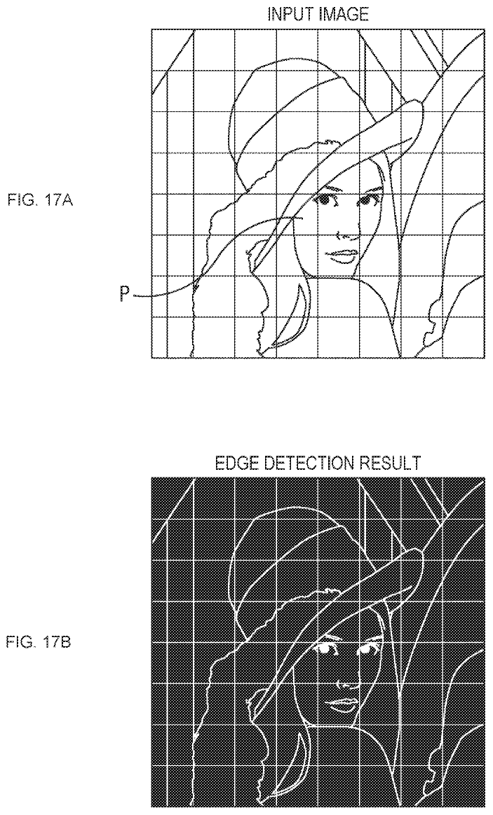

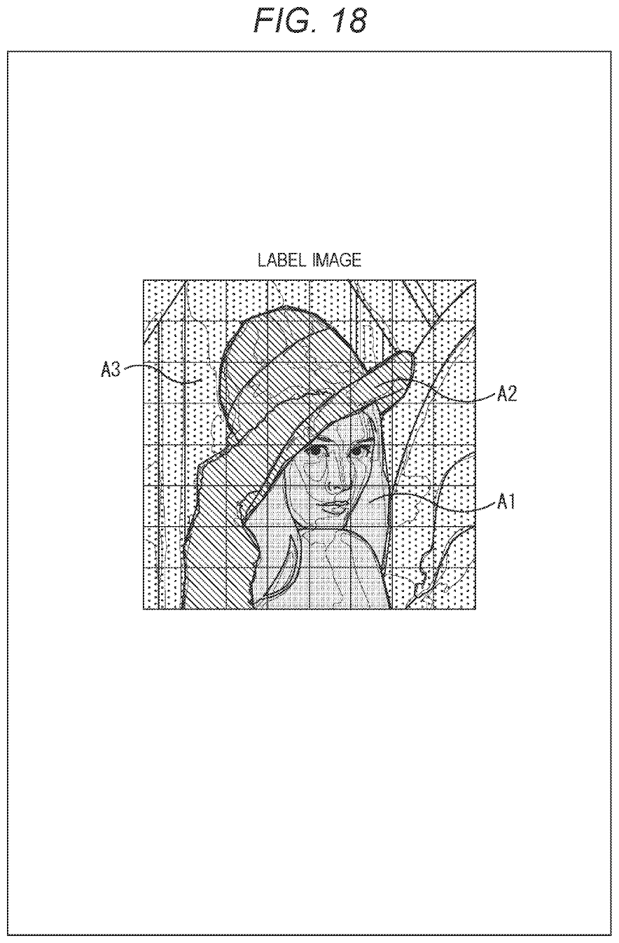

FIGS. 17 and 18 are views illustrating examples of learning data to be used for learning by the object boundary determiner.

As illustrated in FIGS. 17 and 18, an input image, a result of edge detection on the input image, and a label image are used for learning by the object boundary determiner. The label image illustrated in FIG. 18 is the same image as the label image described with reference to FIG. 10. In a region A1, a region A2, and a region A3 of the label image, labels of “person”, “hat”, and “background” are set, respectively.

As illustrated in A of FIG. 17, the input image is sectioned into a plurality of rectangular block regions. A pair of a clipped image obtained by clipping one block region of the input image and an edge image that is an image of a certain edge included in the block region is to be a student image.

Furthermore, as correct answer data, a value of 1 is set in a case where an edge included in the edge image is equal to a label boundary, and a value of 0 is set in a case where the edge is different from the label boundary. The value of the correct answer data is set on the basis of the label image.

The correct answer data in which the value is set in this manner is set as teacher data, and a set of the teacher data and the student image is created as one learning patch.

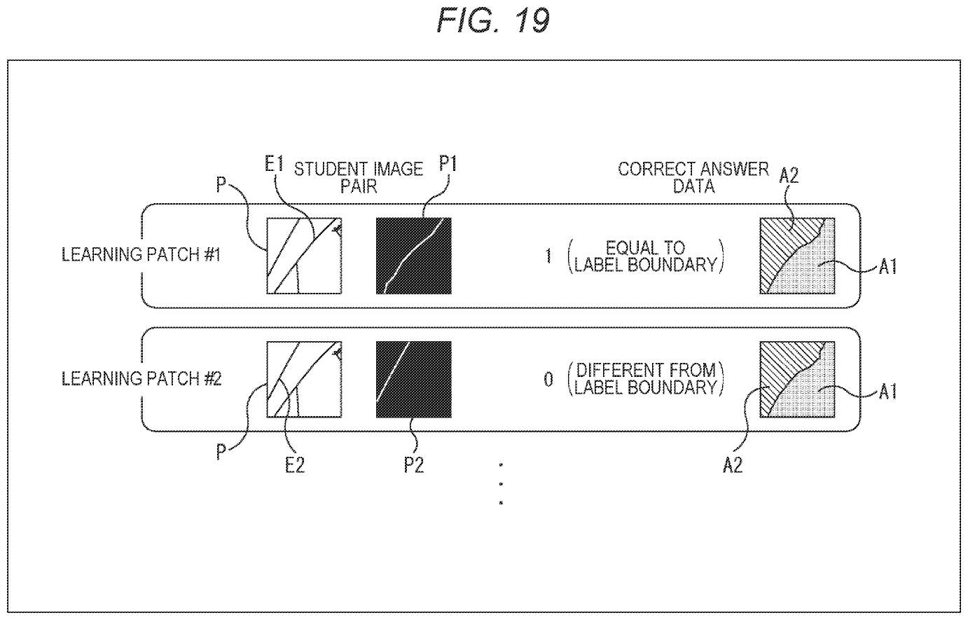

FIG. 19 is a view illustrating an example of a learning patch.

Both a learning patch #1 and a learning patch #2 are learning patches including, in the student images, a clipped image P in the input image in A of FIG. 17. The clipped image P includes at least an edge E1 and an edge E2. The edge E1 is an edge representing a boundary between the face of the person and the hat, and the edge E2 is an edge representing a pattern of the hat.

An edge image P1 constituting a pair of student images of the learning patch #1 together with the clipped image P is an image representing the edge E1. The edge image P1 is created on the basis of a result of edge detection of a region corresponding to the clipped image P.

Whereas, an edge image P2 constituting a pair of student images of the learning patch #2 together with the clipped image P is an image representing the edge E2. The edge image P2 is created on the basis of a result of edge detection of a region corresponding to the clipped image P.

An image illustrated on a right side of FIG. 19 represents a label of a block region corresponding to the clipped image P in the label image. The block region corresponding to the clipped image P includes a label boundary between the region A1 in which the label of “person” is set and the region A2 in which the label of “hat” is set.

The edge E1 represented by the edge image P1 is an edge representing a boundary between the face of the person and the hat, and is equal to the label boundary. In this case, the value of 1 is set as the correct answer data for the student images including the pair of the clipped image P and the edge image P1.

Furthermore, the edge E2 represented by the edge image P2 is an edge representing the pattern of the hat, and is different from the label boundary. In this case, the value of 0 is set as the correct answer data for the student images including the pair of the clipped image P and the edge image P2.

In this way, the learning patch to be used for learning by the object boundary determiner is created by sectioning an input image into block regions and creating a learning patch for each edge in the block region.

The learning patch may be created by sectioning an input region into shapes other than a rectangle. Furthermore, although the value of the correct answer data is assumed to be 1 or 0, a fractional value between 0 to 1 may be used as the value of the correct answer data, on the basis of a degree of correlation or the like.

By performing learning using such a learning patch, the object boundary determiner is created. The object boundary determiner is an inference model that is inputted with a certain image and an edge image and outputs a value indicating whether or not an edge represented by the edge image is equal to a label boundary. In a case where the label boundary is equal to the boundary of the object, this inference model is an inference model for inferring an object boundary degree indicating whether or not the label boundary is equal to the boundary of the object.

Note that learning of coefficients of individual layers constituting the DNN that infers the object boundary degree is performed by the learning unit 12.

In a field of in-vehicle devices and robots, it is desirable to be able to accurately recognize a boundary of an object included in a captured image. Although a boundary line in the image can be extracted by simple edge extraction or segmentation, it is not possible to determine whether the boundary line represents a boundary of an object or a line such as a pattern in the object.

It is also conceivable to determine the boundary of the object by combining information detected by a distance measuring sensor or the like, but in this case, determination cannot be made when two objects are arranged. Furthermore, the boundary cannot be accurately extracted by semantic segmentation.

By using the object boundary determiner as described above, it is possible to accurately recognize the boundary of the object.

Configuration of Image Processing Apparatus 2

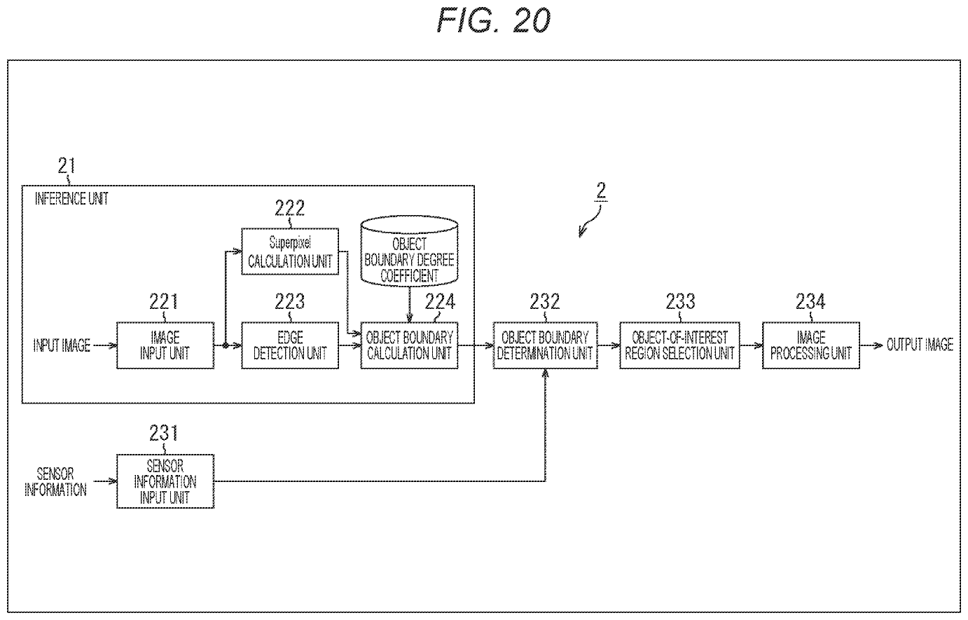

FIG. 20 is a block diagram illustrating a configuration example of the image processing apparatus 2.

As illustrated in FIG. 20, in addition to the inference unit 21, the image processing apparatus 2 is provided with a sensor information input unit 231, an object boundary determination unit 232, an object-of-interest region selection unit 233, and an image processing unit 234.

The inference unit 21 includes an image input unit 221, a superpixel calculation unit 222, an edge detection unit 223, and an object boundary calculation unit 224. The image input unit 221 corresponds to the image input unit 201 in FIG. 15, and the superpixel calculation unit 222 corresponds to the superpixel calculation unit 202 in FIG. 15. Redundant description will be omitted as appropriate. To the object boundary calculation unit 224, an object boundary degree coefficient obtained by learning using a learning patch described with reference to FIG. 19 and the like is supplied.

The image input unit 221 acquires and outputs an input image. The input image outputted from the image input unit 221 is supplied to the superpixel calculation unit 222 and the edge detection unit 223, and is also supplied to each unit in FIG. 20.

The superpixel calculation unit 222 performs segmentation on the input image as a target, and outputs information about each calculated superpixel to the object boundary calculation unit 224.

The edge detection unit 223 detects an edge included in the input image, and outputs a detection result of the edge to the object boundary calculation unit 224.

The object boundary calculation unit 224 creates an input image for determination on the basis of the input image and the edge calculated by the edge detection unit 223. Furthermore, the object boundary calculation unit 224 inputs the input image for determination to the DNN in which the object boundary degree coefficient is set, and calculates an object boundary degree. The object boundary degree calculated by the object boundary calculation unit 224 is supplied to the object boundary determination unit 232.

The sensor information input unit 231 acquires various types of sensor information such as distance information detected by a distance measuring sensor, and outputs the sensor information to the object boundary determination unit 232.

The object boundary determination unit 232 determines whether or not the target edge is a boundary of an object, on the basis of the object boundary degree calculated by the object boundary calculation unit 224. The object boundary determination unit 232 determines whether or not the target edge is a boundary of an object by appropriately using the sensor information and the like supplied from the sensor information input unit 231. A determination result obtained by the object boundary determination unit 232 is supplied to the object-of-interest region selection unit 233.

The object-of-interest region selection unit 233 selects a region of an object of interest to be a target of image processing on the basis of the determination result obtained by the object boundary determination unit 232, and outputs information about the region of the object of interest to the image processing unit 234.

The image processing unit 234 performs image processing such as object recognition and distance estimation, on the region of the object of interest.

Operation of Image Processing Apparatus 2

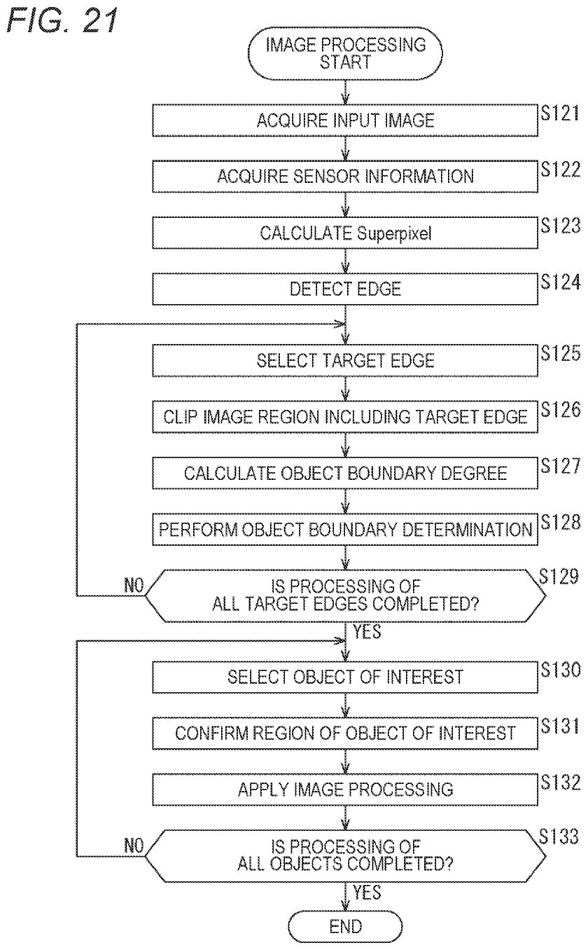

With reference to a flowchart of FIG. 21, processing of the image processing apparatus 2 having the configuration of FIG. 20 will be described.

In step S121, the image input unit 221 acquires an input image.

In step S122, the sensor information input unit 231 acquires sensor information. For example, information on a distance to an object detected by Lidar, and the liked is acquired as the sensor information.

In step S123, the superpixel calculation unit 222 calculates a superpixel. That is, the superpixel calculation unit 222 performs segmentation on the input image as a target, and collects all the pixels of the input image into superpixels, a number of which is smaller than a number of pixels.

In step S124, the edge detection unit 223 detects an edge included in the input image. The edge detection is performed using an existing method such as the Canny method.

In step S125, the object boundary calculation unit 224 specifies an approximate position of the object of interest such as a road or a car on the basis of a calculation result of the superpixel or the like, and selects any edge around the object as a target edge.

A boundary of the superpixel may be selected as the target edge. As a result, it is determined whether or not the boundary of the superpixel is a boundary of the object.

In step S126, the object boundary calculation unit 224 creates a clipped image by clipping a block region including the target edge from the input image. Furthermore, the object boundary calculation unit 224 creates an edge image of the region including the target edge. The creation of the input image for determination including the clipped image and the edge image is performed similarly to the creation of the student image at the time of learning.

In step S127, the object boundary calculation unit 224 inputs the input image for determination to the DNN, and calculates an object boundary degree.

In step S128, the object boundary determination unit 232 performs object boundary determination on the basis of the object boundary degree calculated by the object boundary calculation unit 224.

For example, the object boundary determination unit 232 determines whether or not the target edge is a boundary of the object on the basis of the object boundary degree. In the case of the above-described example, the target edge is determined to be a boundary of the object when a value of the object boundary degree is 1, and the target edge is determined not to be a boundary of the object when the value of the object boundary degree is 0.

The boundary determination by the object boundary determination unit 232 may be performed by combining sensor information acquired by the sensor information input unit 231 and local feature amounts such as brightness and variance, in addition to the object boundary degree.

In step S129, the object boundary determination unit 232 determines whether or not the processing of all the target edges is completed. In a case where it is determined in step S129 that the processing of all the target edges is not completed, the process returns to step S125, and the above process is repeated by changing the target edge.

In this example, the processing is performed on an edge around the object of interest as the target edge, but the processing may be performed on all the edges included in the input image as the target edge.

In a case where it is determined in step S129 that the processing of all the target edges is completed, in step S130, the object-of-interest region selection unit 233 selects the object of interest to be subjected to image processing.

In step S131, the object-of-interest region selection unit 233 confirms a region of the object of interest on the basis of the edge determined as the boundary of the object of interest.

In step S132, the image processing unit 234 performs necessary image processing such as object recognition and distance estimation, on the region of the object of interest.

The image processing may be performed by calculating a feature amount of the object of interest on the basis of pixels constituting the region of the object of interest, and selecting a type of the image processing or adjusting a parameter that defines intensity of the image processing in accordance with the calculated feature amount.

In step S133, the image processing unit 234 determines whether or not the processing of all the objects of interest is completed. In a case where it is determined in step S133 that the processing of all the objects of interest is not completed, the process returns to step S130, and the above process is repeated by changing the object of interest.

In a case where it is determined in step S133 that the processing of all the objects of interest is completed, the process ends.

### Application Example 3: Example of Application to Annotation Tool

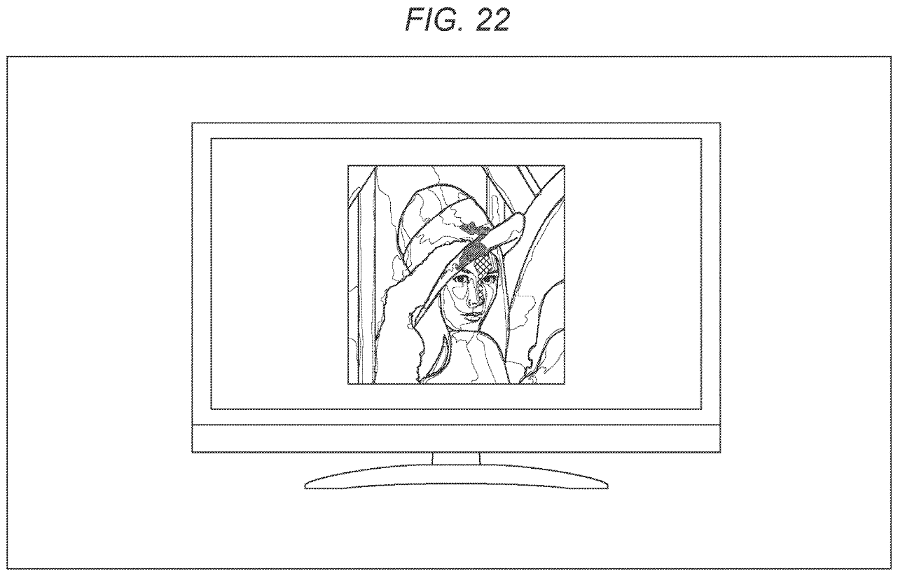

An inference result obtained by the inference unit 21 can be applied to a program to be used as an annotation tool. As illustrated in FIG. 22, the annotation tool is used to display an image to be a processing target and to set a label in each region. A user selects a region and sets a label for the selected region.

In the annotation tool using an inference result obtained by the inference unit 21, there is performed a process of sectioning the entire input image into superpixels, then aggregating the superpixels for each object, and setting a label for each object. Since it is used for aggregation of superpixels, the inference result obtained by the inference unit 21 is similarity indicating whether or not two superpixels are superpixels of a same object, similarly to the application example described with reference to FIG. 15 and the like.

In a normal annotation tool, a target object for which a label is to be set is selected by surrounding the target object with a rectangular or polygonal frame. In a case where a shape of the target object is a complicated shape, such selection is difficult.

Furthermore, labels are set in units of superpixels in some cases, but it takes time and effort for a user to set a label for each of a large number of superpixels.

By aggregating superpixels for each object and presenting the superpixels to the user to allow the label to be set, the user can easily set the label for each object having various shapes.

<Case 1>

Configuration of Image Processing Apparatus 2

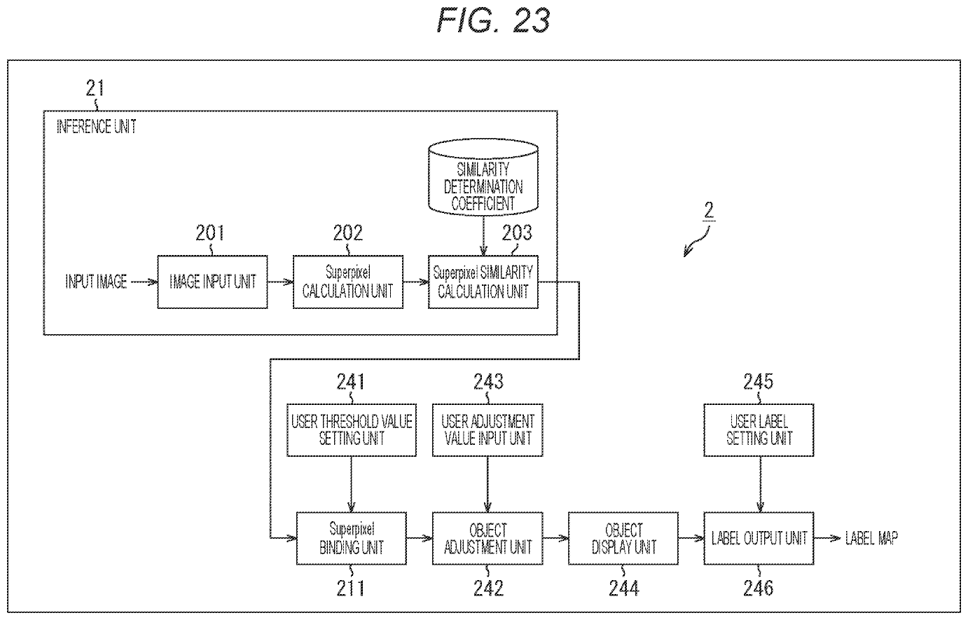

FIG. 23 is a block diagram illustrating a configuration example of the image processing apparatus 2.

As illustrated in FIG. 23, in a subsequent stage of the inference unit 21, there are provided a superpixel binding unit 211, a user threshold value setting unit 241, an object adjustment unit 242, a user adjustment value input unit 243, an object display unit 244, a user label setting unit 245, and a label output unit 246. In FIG. 23, the same configuration as configuration illustrated in FIG. 15 are denoted by the same reference numerals. Redundant description will be omitted as appropriate.

The inference unit 21 includes an image input unit 201, a superpixel calculation unit 202, and a superpixel similarity calculation unit 203. A configuration of the inference unit 21 is the same as the configuration of the inference unit 21 described with reference to FIG. 15.

The user threshold value setting unit 241 adjusts a threshold value serving as a reference for superpixel binding determination performed by the superpixel binding unit 211, in accordance with a user's operation.

The object adjustment unit 242 adds and deletes a superpixel constituting an object in accordance with a user's operation. By the addition and deletion of the superpixels, a shape of the object is adjusted. The object adjustment unit 242 outputs information about the object after the shape adjustment, to the object display unit 244.

The user adjustment value input unit 243 receives a user's operation related to addition and deletion of superpixels, and outputs information indicating contents of the user's operation to the object adjustment unit 242.

On the basis of the information supplied from the object adjustment unit 242, the object display unit 244 displays a boundary line of the superpixel and a boundary line of the object, to be superimposed on the input image.

The user label setting unit 245 sets a label for each object in accordance with a user's operation, and outputs information about the label that is set for each object, to the label output unit 246.

The label output unit 246 outputs a labeling result for each object as a map.

Operation of Image Processing Apparatus 2

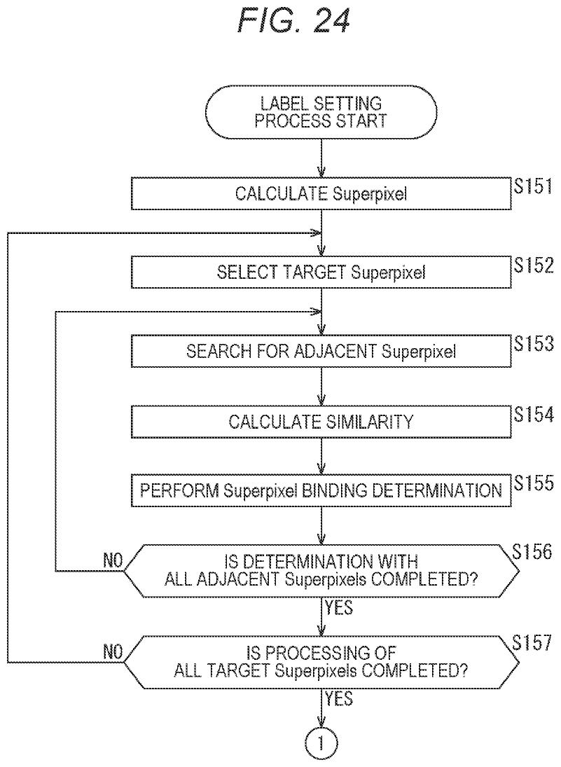

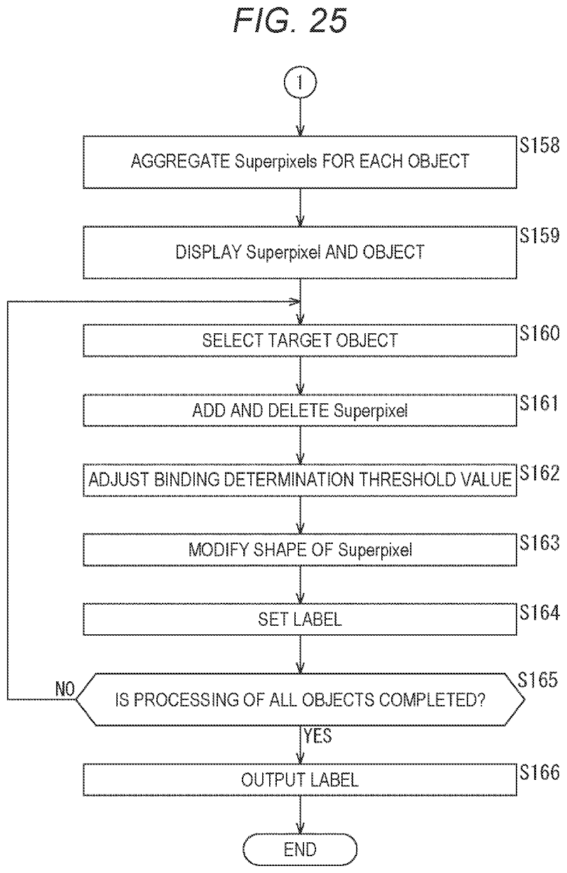

With reference to flowcharts of FIGS. 24 and 25, processing of the image processing apparatus 2 having the configuration of FIG. 23 will be described.

The processing in steps S151 to S157 in FIG. 24 is similar to the processing in steps S101 to S107 in FIG. 16. Superpixels are calculated on the basis of an input image, and binding determination is performed on the basis of similarity between all target superpixels and adjacent superpixels.

In step S158 of FIG. 25, the superpixel binding unit 211 of FIG. 23 aggregates superpixels for each object on the basis of a result of the binding determination between the target superpixels and the adjacent superpixels. The binding determination by the superpixel binding unit 211 is appropriately performed by combining feature amounts such as a distance and a spatial distance of pixel values of pixels constituting two superpixels, in addition to the similarity.

In step S159, the object display unit 244 displays a boundary line of the superpixel and a boundary line of the object, to be superimposed on the input image. For example, the boundary line of the superpixel is displayed by a dotted line, and the boundary line of the object is displayed by a solid line.

In step S160, the user label setting unit 245 selects a target object, which is an object for which a label is to be set, in accordance with a user's operation. The user can select an object desired to be labeled by performing a click operation or the like on a GUI.

In step S161, the object adjustment unit 242 adds and deletes a superpixel constituting the object in accordance with a user's operation. In a case where automatically aggregated superpixels are different from those as intended, the user can add or delete superpixels constituting the object. The operation by the user is received by the user adjustment value input unit 243 and inputted to the object adjustment unit 242.

For example, the user can adjust superpixels constituting the object by selecting an addition tool or a deletion tool and then selecting a predetermined superpixel by a click operation. An adjustment result is reflected on display of a screen in real time.

In step S162, the user threshold value setting unit 241 adjusts a threshold value serving as a reference for superpixel binding determination, in accordance with a user's operation. The operation by the user is received by the user threshold value setting unit 241, and the adjusted threshold value is inputted to the superpixel binding unit 211.

For example, the user can adjust the threshold value by operating a slide bar or operating a wheel of a mouse. A result of the binding determination based on the adjusted threshold value is reflected on display of the screen in real time.

In this way, in a case where the way of aggregation of superpixels constituting the object is different from that as intended, the user can adjust the threshold value serving as a reference for superpixel binding determination by an operation on the GUI. Since the aggregation result of the superpixel according to the adjusted threshold value is displayed in real time, the user can adjust the threshold value while viewing a degree of aggregation.

In a case where feature amounts such as a distance and a spatial distance of pixel values are used in superpixel binding determination, these feature amounts may be adjusted by the user.

In step S163, the object adjustment unit 242 modifies a shape of the superpixel in accordance with a user's operation. By modifying the shape of the superpixel, the user can modify the shape of the object.

For example, a marker indicating a contour of each superpixel is displayed. The user can modify the shape of the superpixel in real time by dragging the marker.

In this way, in a case where an automatically calculated shape of the superpixel is different from that as intended, the user can modify the shape of each superpixel.

In step S164, the user label setting unit 245 sets a label for the object whose shape and the like have been adjusted, in accordance with a user's operation.

In step S165, the label output unit 246 determines whether or not the processing of all the objects is completed. In a case where it is determined in step S165 that the processing of all the objects is not completed, the process returns to step S160, and the above process is repeated by changing the target object.

In a case where it is determined in step S165 that the processing of all the objects is completed, in step S166, the label output unit 246 outputs a labeling result for each object as a map, and ends the process. Unlabeled objects may remain.

Through the above process, the user can customize a degree of aggregation of superpixels constituting the object and the shape of the object, and set a label for each object.

<Case 2>

Configuration of Image Processing Apparatus 2

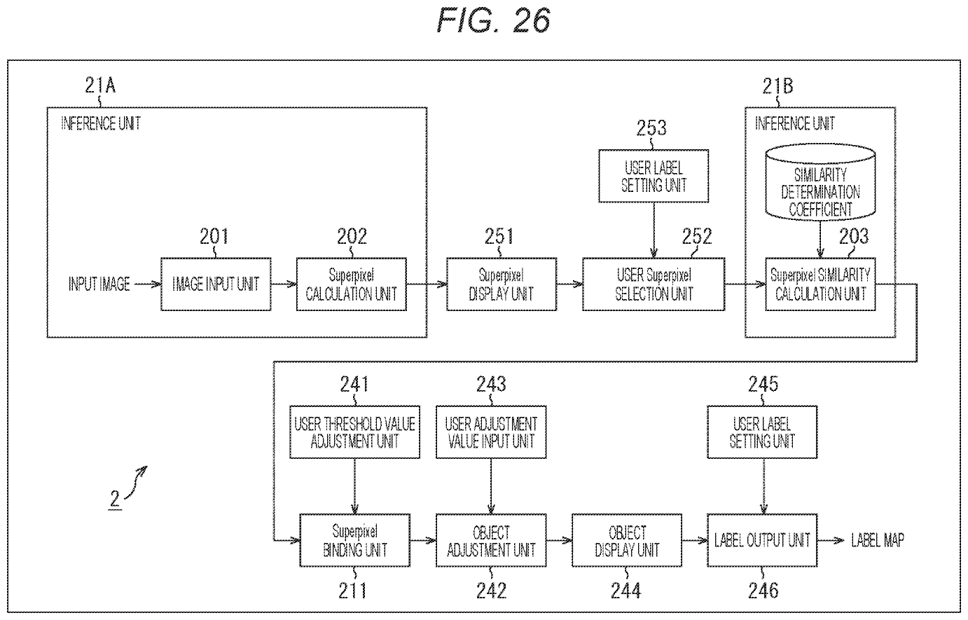

FIG. 26 is a block diagram illustrating another configuration example of the image processing apparatus 2.

In the image processing apparatus 2 illustrated in FIG. 26, after an input image is sectioned into superpixels, the user can set a label for each superpixel. In a case where the user sets a label for a certain superpixel, the same label is set for other superpixels constituting a same object as that superpixel.

In the example of FIG. 26, the inference unit 21 is provided by being sectioned into an inference unit 21A and an inference unit 21B. The image input unit 201 and the superpixel calculation unit 202 are provided in the inference unit 21A, and the superpixel similarity calculation unit 203 is provided in the inference unit 21B. Between the inference unit 21A and the inference unit 21B, a superpixel display unit 251, a user superpixel selection unit 252, and a user label setting unit 253 are provided.

Similarly to the case described with reference to FIG. 23, there are provided the superpixel binding unit 211, the user threshold value setting unit 241, the object adjustment unit 242, the user adjustment value input unit 243, the object display unit 244, the user label setting unit 245, and the label output unit 246 in a subsequent stage of the inference unit 21B. Redundant description will be omitted as appropriate.

The superpixel display unit 251 displays a boundary line of a superpixel, to be superimposed on the input image, on the basis of a calculation result of the superpixel by the superpixel calculation unit 202.

The user superpixel selection unit 252 selects a target superpixel for which a label is set, in accordance with a user's operation.

The user label setting unit 253 sets a label for the superpixel in accordance with a user's operation.

Operation of Image Processing Apparatus 2

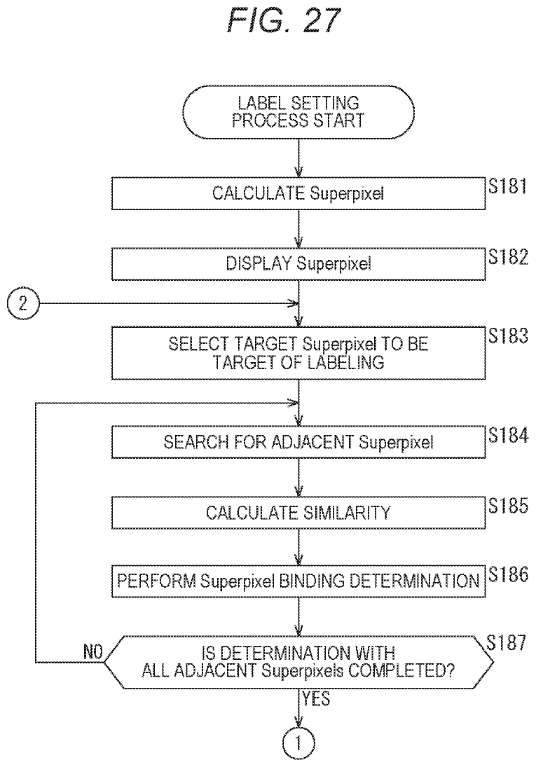

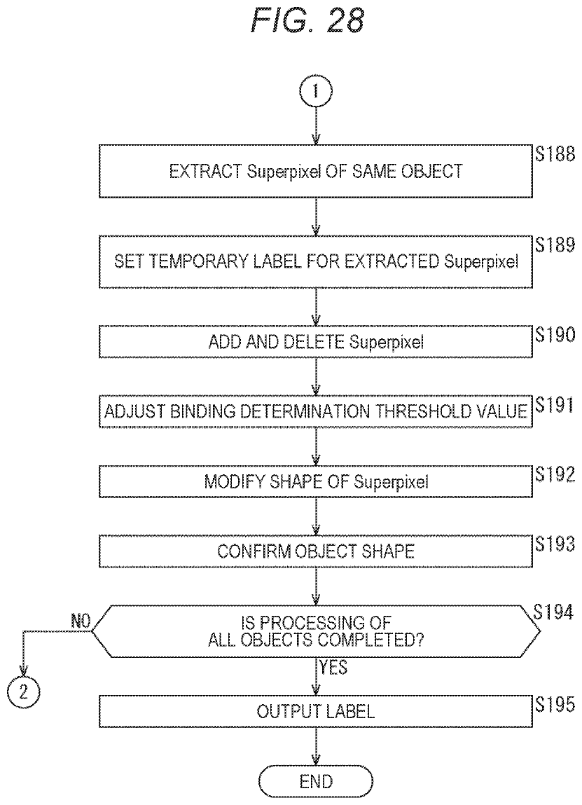

With reference to flowcharts of FIGS. 27 and 28, processing of the image processing apparatus 2 having the configuration of FIG. 26 will be described.

In step S181, the superpixel calculation unit 202 performs segmentation on an input image as a target, and collects all the pixels of the input image into superpixels, a number of which is smaller than a number of pixels.

In step S182, the superpixel display unit 251 displays a boundary line of the superpixel, to be superimposed on the input image.

In step S183, the user superpixel selection unit 252 selects a target superpixel, which is a superpixel to which a label is to be set, in accordance with a user's operation. The operation by the user is received by the user label setting unit 253, and inputted to the user superpixel selection unit 252.

After selecting a predetermined label by using a label tool on the GUI, the user selects a superpixel to which the label is desired to be given by a click operation or the like. In order to facilitate recognition of a state of being selected as the target superpixel, color corresponding to the label is displayed translucently for the selected superpixel.

The processing in steps S184 to S187 is similar to the processing in steps S153 to S156 in FIG. 24. Similarity between all target superpixels and adjacent superpixels is calculated, and binding determination is performed.

In order to reduce a processing time, the binding determination may be performed between with only a superpixel adjacent to the target superpixel each time the user selects the target superpixel. A calculation amount can be reduced by performing the binding determination between with only superpixels within a range of a predetermined distance.

Of course, it is also possible to make the binding determination between with superpixels at distant positions or all superpixels. By performing the binding determination at a waiting time of processing, the waiting time can be effectively utilized.

In step S188, the superpixel binding unit 211 extracts a superpixel of a same object as the target superpixel selected by the user, on the basis of the similarity calculated by the superpixel similarity calculation unit 203.

In step S189, the superpixel binding unit 211 sets, as a temporary label, a same label as the label initially selected by the user for the extracted superpixel. As a result, the same label as the label selected by the user is set to the superpixel of the same object as the target superpixel. For example, the superpixel to which the temporary label is set is displayed in a lighter color than the target superpixel.

The processing in steps S190 to S192 is similar to the processing in steps S161 to S163 in FIG. 25.

That is, in step S190, the object adjustment unit 242 adds and deletes a superpixel constituting the object in accordance with a user's operation. It is also possible to add and delete a plurality of superpixels collectively, instead of adding and deleting superpixels one by one. For example, in a case where the user has added a superpixel, the same temporary labels are collectively set for superpixels similar to the superpixel. Conversely, in a case where the user has deleted a superpixel, temporary labels of superpixels similar to the superpixel are collectively deleted.

An average value of feature amounts in the object may be recalculated every time the user adds or deletes a superpixel constituting the object, and the binding determination may be performed using the recalculated feature amounts.

In step S191, the user threshold value setting unit 241 adjusts a threshold value serving as a reference for superpixel binding determination, in accordance with a user's operation.

In step S192, the object adjustment unit 242 modifies a shape of the superpixel in accordance with a user's operation.

In step S193, the label output unit 246 confirms the shape of the object, and confirms the label of the superpixel constituting the object as the label of the object.

In step S194, the label output unit 246 determines whether or not the processing of all the objects is completed. In a case where it is determined in step S194 that the processing of all the objects is not completed, the process returns to step S183 in FIG. 27, and the above process is repeated by changing the target superpixel.

In a case where it is determined in step S194 that the processing of all the objects is completed, in step S195, the label output unit 246 outputs a labeling result for each object as a map, and ends the process.

Through the above process, the user can customize a degree of aggregation of superpixels constituting the object and the shape of the object, and set a label for each superpixel.

The above process can be applied not only to a program of the annotation tool but also to various programs that performs region sectioning on the image.

<<Others>>

A combination of superpixels selected as a learning target at the time of learning or a combination of superpixels selected as an inference target at the time of inference has been assumed to be two superpixels (a superpixel pair), but a combination of three or more superpixels may be selected.

About Program

The series of processing described above can be executed by hardware or software. In a case of executing the series of processing by software, a program that forms the software is installed from a program recording medium to a computer incorporated in dedicated hardware, to a general-purpose personal computer, or the like.

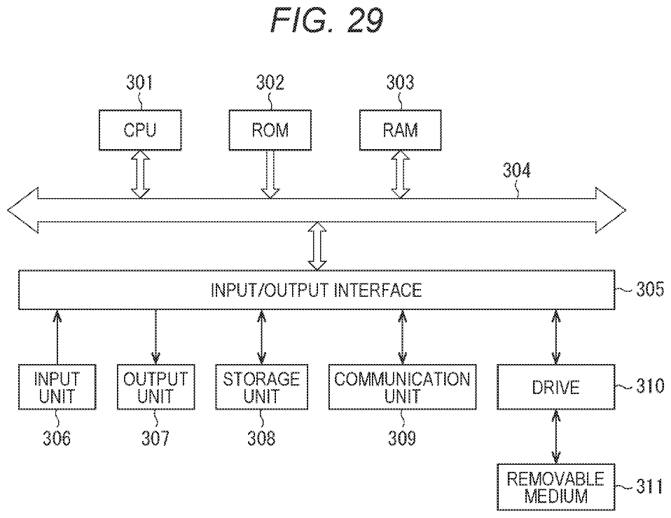

FIG. 29 is a block diagram illustrating a configuration example of hardware of a computer that executes the series of processing described above in accordance with a program.

A central processing unit (CPU) 301, a read only memory (ROM) 302, and a random access memory (RAM) 303 are mutually connected by a bus 304.

The bus 304 is further connected with an input/output interface 305. The input/output interface 305 is connected with an input unit 306 including a keyboard, a mouse, and the like, and an output unit 307 including a display, a speaker, and the like. Furthermore, the input/output interface 305 is connected with a storage unit 308 including a hard disk, a non-volatile memory, and the like, a communication unit 309 including a network interface and the like, and a drive 310 that drives a removable medium 311.

In the computer configured as described above, the series of processing described above are performed, for example, by the CPU 301 loading a program recorded in the storage unit 308 into the RAM 303 via the input/output interface 305 and the bus 304, and executing.

The program to be executed by the CPU 301 is provided, for example, by being recorded on the removable medium 311 or via wired or wireless transfer media such as a local area network, the Internet, and digital broadcasting, to be installed in the storage unit 308.

Note that the program executed by the computer may be a program that performs processing in time series according to an order described in this specification, or may be a program that performs processing in parallel or at necessary timing such as when a call is made.

In this specification, the system means a set of a plurality of components (a device, a module (a part), and the like), and it does not matter whether or not all the components are in the same housing. Therefore, a plurality of devices housed in separate housings and connected via a network, and a single device with a plurality of modules housed in one housing are both systems.

The effects described in this specification are merely examples and are not limited, and other effects may also be present.

The embodiments of the present technology are not limited to the above-described embodiments, and various modifications can be made without departing from the scope of the present technology.

For example, the present technology can have a cloud computing configuration in which one function is shared and processed in cooperation by a plurality of devices via a network.

Furthermore, each step described in the above-described flowchart can be executed by one device, and also shared and executed by a plurality of devices.

Moreover, in a case where one step includes a plurality of processes, the plurality of processes included in the one step can be executed by one device, and also shared and executed by a plurality of devices.

Combination Example of Configuration

The present technology can also have the following configurations.

(1)

An image processing apparatus including:

an inference unit configured to input, to an inference model, as an input image for determination, an image of a region including at least a part of each superpixel constituting a combination of any plurality of superpixels, in a processing target image including an object, the inference unit being configured to infer whether or not a plurality of superpixels constituting the combination is superpixels of a same object; and

an aggregation unit configured to aggregate superpixels constituting the processing target image for each object on the basis of an inference result obtained using the inference model.

(2)

The image processing apparatus according to (1), further including:

a feature amount calculation unit configured to calculate a feature amount of a processing target object, on the basis of an aggregated superpixel; and

an image processing unit configured to perform image processing according to a feature amount of the processing target object.

(3)

The image processing apparatus according to (1) or (2), in which

the inference unit inputs, to the inference model, a plurality of the input images for determination including a region of each superpixel constituting the combination or a rectangular region including each superpixel, and the inference unit performs inference.

(4)

The image processing apparatus according to (1) or (2), in which the inference unit inputs, to the inference model, a plurality of the input images for determination including a partial region in each superpixel constituting the combination, and the inference unit performs inference.

(5)

The image processing apparatus according to (1) or (2), in which

the inference unit inputs, to the inference model, one of the input image for determination including a region of an entire superpixel constituting the combination or a rectangular region including an entire superpixel constituting the combination, and the inference unit performs inference.

(6)

The image processing apparatus according to any one of (1) to (5), in which

the inference unit selects, as the combination, a pair of two superpixels including a first superpixel to be a target and a second superpixel adjacent to the first superpixel.

(7)

The image processing apparatus according to any one of (1) to (5), in which

the inference unit selects, as the combination, a pair of two superpixels including a first superpixel to be a target and a second superpixel at a position away from the first superpixel.

(8)

The image processing apparatus according to any one of (1) to (7), further including:

a display control unit configured to display information indicating a region of each object, to be superimposed on the processing target image, on the basis of an aggregated superpixel; and

a setting unit configured to set a label for a region of each object in accordance with an operation by a user.

(9)

An image processing method to be performed by an image processing apparatus,

the image processing method including:

inputting, to an inference model, as an input image for determination, an image of a region including at least a part of each superpixel constituting a combination of any plurality of superpixels, in a processing target image including an object, and inferring whether or not a plurality of superpixels constituting the combination is superpixels of a same object; and

aggregating superpixels constituting the processing target image for each object on the basis of an inference result obtained using the inference model.

(10)

A program for causing a computer to execute

processing including:

inputting, to an inference model, as an input image for determination, an image of a region including at least a part of each superpixel constituting a combination of any plurality of superpixels, in a processing target image including an object, and inferring whether or not a plurality of superpixels constituting the combination is superpixels of a same object; and

aggregating superpixels constituting the processing target image for each object on the basis of an inference result obtained using the inference model.

(11)

A learning device including:

a student image creation unit configured to create, as a student image, an image of a region including at least a part of each superpixel constituting a combination of any plurality of superpixels, in a processing target image including an object;

a teacher data calculation unit configured to calculate teacher data according to whether or not a plurality of superpixels constituting the combination is superpixels of a same object, on the basis of a label image corresponding to the processing target image; and

a learning unit configured to learn a coefficient of an inference model by using a learning patch including the student image and the teacher data.

(12)

The learning device according to (11), in which

the student image creation unit creates a plurality of the student images including a region of each superpixel constituting the combination or a rectangular region including each superpixel.

(13)

The learning device according to (11), in which

the student image creation unit creates a plurality of the student images including a partial region in each superpixel constituting the combination.

(14)

The learning device according to (11), in which

the student image creation unit creates one of the student image including a region of an entire superpixel constituting the combination or a rectangular region including an entire superpixel constituting the combination.

(15)

The learning device according to any one of (11) to (14), in which

the student image creation unit selects, as the combination, a pair of two superpixels including a first superpixel to be a target and a second superpixel adjacent to the first superpixel.

(16)

The learning device according to any one of (11) to (14), in which

the student image creation unit selects, as the combination, a pair of two superpixels including a first superpixel to be a target and a second superpixel at a position away from the first superpixel.

(17)

A learning method to be performed by a learning device,

the learning method including:

creating, as a student image, an image of a region including at least a part of each superpixel constituting a combination of any plurality of superpixels, in a processing target image including an object;

calculating teacher data according to whether or not a plurality of superpixels constituting the combination is superpixels of a same object, on the basis of a label image corresponding to the processing target image; and

learning a coefficient of an inference model by using a learning patch including the student image and the teacher data.

(18)

A program for causing a computer to execute

processing including:

creating, as a student image, an image of a region including at least a part of each superpixel constituting a combination of any plurality of superpixels, in a processing target image including an object;

calculating teacher data according to whether or not a plurality of superpixels constituting the combination is superpixels of a same object, on the basis of a label image corresponding to the processing target image; and

learning a coefficient of an inference model by using a learning patch including the student image and the teacher data.

### REFERENCE SIGNS LIST

1 Learning device
2 Image processing apparatus
11 Learning patch creation unit
12 Learning unit
21 Inference unit
51 Image input unit
52 Superpixel calculation unit
53 Superpixel pair selection unit
54 Relevant image clipping unit
55 Student image creation unit
56 Label input unit
57 Relevant label reference unit
58 Correct answer data calculation unit
59 Learning patch group output unit
71 Student image input unit
72 Correct answer data input unit
73 Network construction unit
74 Deep learning unit
75 Loss calculation unit
76 Learning end determination unit
77 Coefficient output unit
91 Image input unit
92 Superpixel calculation unit
93 Superpixel pair selection unit
94 Relevant image clipping unit
95 Determination input image creation unit
96 Network construction unit
97 Inference unit

1. An image processing apparatus comprising:
an inference unit configured to input, to an inference model, as an input image for determination, an image of a region including at least a part of each superpixel constituting a combination of any plurality of superpixels, in a processing target image including an object, the inference unit being configured to infer whether or not a plurality of superpixels constituting the combination is superpixels of a same object; and
an aggregation unit configured to aggregate superpixels constituting the processing target image for each object on a basis of an inference result obtained using the inference model.

2. The image processing apparatus according to claim 1, further comprising:
a feature amount calculation unit configured to calculate a feature amount of a processing target object, on a basis of an aggregated superpixel; and
an image processing unit configured to perform image processing according to a feature amount of the processing target object.

3. The image processing apparatus according to claim 1, wherein
the inference unit inputs, to the inference model, a plurality of the input images for determination including a region of each superpixel constituting the combination or a rectangular region including each superpixel, and the inference unit performs inference.

4. The image processing apparatus according to claim 1, wherein
the inference unit inputs, to the inference model, a plurality of the input images for determination including a partial region in each superpixel constituting the combination, and the inference unit performs inference.

5. The image processing apparatus according to claim 1, wherein
the inference unit inputs, to the inference model, one of the input image for determination including a region of an entire superpixel constituting the combination or a rectangular region including an entire superpixel constituting the combination, and the inference unit performs inference.

6. The image processing apparatus according to claim 1, wherein
the inference unit selects, as the combination, a pair of two superpixels including a first superpixel to be a target and a second superpixel adjacent to the first superpixel.

7. The image processing apparatus according to claim 1, wherein
the inference unit selects, as the combination, a pair of two superpixels including a first superpixel to be a target and a second superpixel at a position away from the first superpixel.

8. The image processing apparatus according to claim 1, further comprising:
a display control unit configured to display information indicating a region of each object, to be superimposed on the processing target image, on a basis of an aggregated superpixel; and
a setting unit configured to set a label for a region of each object in accordance with an operation by a user.

9. An image processing method to be performed by an image processing apparatus,
the image processing method comprising:
inputting, to an inference model, as an input image for determination, an image of a region including at least a part of each superpixel constituting a combination of any plurality of superpixels, in a processing target image including an object, and inferring whether or not a plurality of superpixels constituting the combination is superpixels of a same object; and
aggregating superpixels constituting the processing target image for each object on a basis of an inference result obtained using the inference model.

10. A program for causing a computer to execute
processing comprising:
inputting, to an inference model, as an input image for determination, an image of a region including at least a part of each superpixel constituting a combination of any plurality of superpixels, in a processing target image including an object, and inferring whether or not a plurality of superpixels constituting the combination is superpixels of a same object; and
aggregating superpixels constituting the processing target image for each object on a basis of an inference result obtained using the inference model.

11. A learning device comprising:
a student image creation unit configured to create, as a student image, an image of a region including at least a part of each superpixel constituting a combination of any plurality of superpixels, in a processing target image including an object;
a teacher data calculation unit configured to calculate teacher data according to whether or not a plurality of superpixels constituting the combination is superpixels of a same object, on a basis of a label image corresponding to the processing target image; and
a learning unit configured to learn a coefficient of an inference model by using a learning patch including the student image and the teacher data.

12. The learning device according to claim 11, wherein
the student image creation unit creates a plurality of the student images including a region of each superpixel constituting the combination or a rectangular region including each superpixel.

13. The learning device according to claim 11, wherein
the student image creation unit creates a plurality of the student images including a partial region in each superpixel constituting the combination.

14. The learning device according to claim 11, wherein
the student image creation unit creates one of the student image including a region of an entire superpixel constituting the combination or a rectangular region including an entire superpixel constituting the combination.

15. The learning device according to claim 11, wherein
the student image creation unit selects, as the combination, a pair of two superpixels including a first superpixel to be a target and a second superpixel adjacent to the first superpixel.

16. The learning device according to claim 11, wherein
the student image creation unit selects, as the combination, a pair of two superpixels including a first superpixel to be a target and a second superpixel at a position away from the first superpixel.

17. A learning method to be performed by a learning device,
the learning method comprising:
creating, as a student image, an image of a region including at least a part of each superpixel constituting a combination of any plurality of superpixels, in a processing target image including an object;
calculating teacher data according to whether or not a plurality of superpixels constituting the combination is superpixels of a same object, on a basis of a label image corresponding to the processing target image; and
learning a coefficient of an inference model by using a learning patch including the student image and the teacher data.

18. A program for causing a computer to execute
processing comprising:
creating, as a student image, an image of a region including at least a part of each superpixel constituting a combination of any plurality of superpixels, in a processing target image including an object;
calculating teacher data according to whether or not a plurality of superpixels constituting the combination is superpixels of a same object, on a basis of a label image corresponding to the processing target image; and
learning a coefficient of an inference model by using a learning patch including the student image and the teacher data.
